(19) United States
(12) Patent Application Publication
(10) Pub. No.: US 2017/0034145 A1
(43) Pub. Date: Feb. 2, 2017

(54) INFORMATION PROCESSING SYSTEM, INFORMATION PROCESSING APPARATUS, AND METHOD FOR PROCESSING INFORMATION

(71) Applicant: Takeshi Shimazaki, Kanagawa (JP)

(72) Inventor: Takeshi Shimazaki, Kanagawa (JP)

(73) Assignee: Ricoh Company, Ltd., Tokyo (JP)

(21) Appl. No.: 15/195,980

(22) Filed: Jun. 28, 2016

(30) Foreign Application Priority Data
Jul. 30, 2015 (JP) 2015151224

(51) Int. Cl. H04L 29/06

(52) U.S. Cl. CPC H04L 63/08

(57) ABSTRACT

An information processing system includes a terminal device, and an information processing apparatus configured to execute one of a plurality of actions responding to an action request from the terminal device. The terminal device includes a switching unit configured to switch modes between a first mode and a second mode, a generating unit configured to generate mode identifying information, and a sending unit configured to send the action request and the mode identifying information. The information processing apparatus includes an execution unit configured to limit execution of an action requested by the action request for which the mode identifying information indicates the first mode when the requested action is among a predetermined one or more of the plurality of actions, and configured to execute, regardless of which one of the plurality of actions the requested action is, the requested action for which the mode identifying information indicates the second mode.

### CROSS-REFERENCE TO RELATED APPLICATIONS

The present application is based on and claims the benefit of priority under 35 U.S.C. §119 of Japanese Patent Application No. 2015-151224, filed Jul. 30, 2015, the contents of which are hereby incorporated herein by reference in their entirety.

### BACKGROUND OF THE INVENTION

1. Field of the Invention

The present disclosure relates to information processing systems, information processing apparatuses, and methods for processing information.

2. Description of the Related Art

Devices having a security mode, in which a security function is enhanced, are known to be suitable for the purpose of BYOD (Bring your own device) where personally owned devices such as smart phones and tablets are used for job-related purposes. For example, a user may use his/her personal smartphone for job-related purposes after switching the phone from a normal mode to a security mode, thereby preventing leaks of confidential information, intrusions of spyware into systems, etc.

As an example, a smartphone is known in the art that has a security mode for job-related use in order to prevent leaks of confidential information, in addition to a normal mode for non-job-related use (for example, Japanese Unexamined Patent Application Publication No. 2014-116008).

### SUMMARY OF THE INVENTION

However, according to conventional art, sufficient collaboration to provide security between devices and apparatuses to be connected has not been achieved.

For example, in the case where an apparatus such as an MFP (Multifunction Peripheral Printer), a data storage server, a projector, an electronic blackboard, and a system for teleconferencing is used through a device such as a smartphone connected to the apparatus, the apparatus has difficulties detecting the current mode of the device. This means that the apparatus can be used through the device during the normal mode, where security is vulnerable, which can cause leaks of information.

Therefore, an object of the present invention is to enhance collaboration to provide security between devices and apparatuses to be connected.

According to one aspect of the present invention, an information processing system includes a terminal device, and an information processing apparatus configured to execute one of a plurality of actions in response to an action request from the terminal device. The terminal device includes a switching unit configured to switch modes between a first mode used for requesting an external apparatus to execute an action and a second mode used for requesting the information processing apparatus to execute an action, the external apparatus being any one of the information processing apparatus and one or more other apparatuses, a generating unit configured to generate mode identifying information indicative of a mode used for generating the action request, and a sending unit configured to send the action request and the mode identifying information. The information processing apparatus includes an execution unit configured to limit execution of an action requested by the action request for which the mode identifying information indicates the first mode when the requested action is among a predetermined one or more of the plurality of actions, and configured to execute, regardless of which one of the plurality of actions the requested action is, the requested action for which the mode identifying information indicates the second mode.

Collaboration to provide security between devices and apparatuses to be connected can be enhanced.

### BRIEF DESCRIPTION OF THE DRAWINGS

FIG. 1 is a drawing illustrating an example of a configuration of an information processing system which connects a terminal device to equipment at a workplace;

FIG. 2 is a drawing illustrating an example of a functional configuration of the terminal device;

FIG. 3 is a drawing illustrating an example of an action requesting table;

FIG. 4 is a drawing illustrating an example of a functional configuration of an application executing unit;

FIGS. 5A and 5B are drawings illustrating a first example of screens to provide an instruction to switch the mode;

FIGS. 5C and 5D are drawings illustrating a second example of screens to provide an instruction to switch the mode;

FIG. 6 is a drawing illustrating an example of a functional configuration of an information processing apparatus relating to a first embodiment;

FIG. 7 is a drawing illustrating a first example of a determining table;

FIG. 8 is a drawing illustrating a processing sequence in the terminal device and the information processing apparatus relating to the first embodiment;

FIG. 9 is a drawing illustrating a flowchart of a process performed between the terminal device and the information processing apparatus relating to the first embodiment;

FIGS. 10A and 10B are drawings illustrating examples of a displayed performance result sent to the terminal device;

FIG. 11 is a drawing illustrating an example of a functional configuration of an information processing apparatus relating to a second embodiment;

FIG. 12 is a drawing illustrating a second example of the determining table;

FIG. 13 is a drawing illustrating a processing sequence in the terminal device and the information processing apparatus relating to the second embodiment;

FIG. 14 is a drawing illustrating a flowchart of a process performed between the terminal device and the information processing apparatus relating to the second embodiment;

FIGS. 15A and 15B are drawings illustrating examples of a display relating to a mode switching of the terminal device;

FIG. 16 is a drawing illustrating an example of a functional configuration of an information processing apparatus relating to a third embodiment;

FIG. 17 is a drawing illustrating a third example of the determining table;

FIG. 18 is a drawing illustrating an example of an authentication table;

FIG. 19 is a drawing illustrating a first example of an operation panel displayed on the display unit;

FIG. 20 is a drawing illustrating a second example of the operation panel displayed on the display unit;

FIG. 21 is a drawing illustrating a flowchart of setting an acceptance of an action request;

FIG. 22 is a drawing illustrating an example of a hardware configuration of an MFP/LP relating to the information processing apparatus described in the first embodiment through the third embodiment;

FIG. 23 is a block diagram illustrating an example of a software configuration of the MFP/LP;

FIG. 24 is a drawing illustrating an example of a hardware configuration of the terminal device; and

FIG. 25 is a drawing illustrating an example of a screen for reporting that the information processing apparatus does not support a security function.

### DESCRIPTION OF THE EMBODIMENTS

In the following, embodiments of the present invention are described with reference to the accompanying drawings. In the specification and the drawings of the present invention, the same reference symbols are attached to the elements having substantially the same functional configurations and duplicate descriptions are omitted.

### First Embodiment

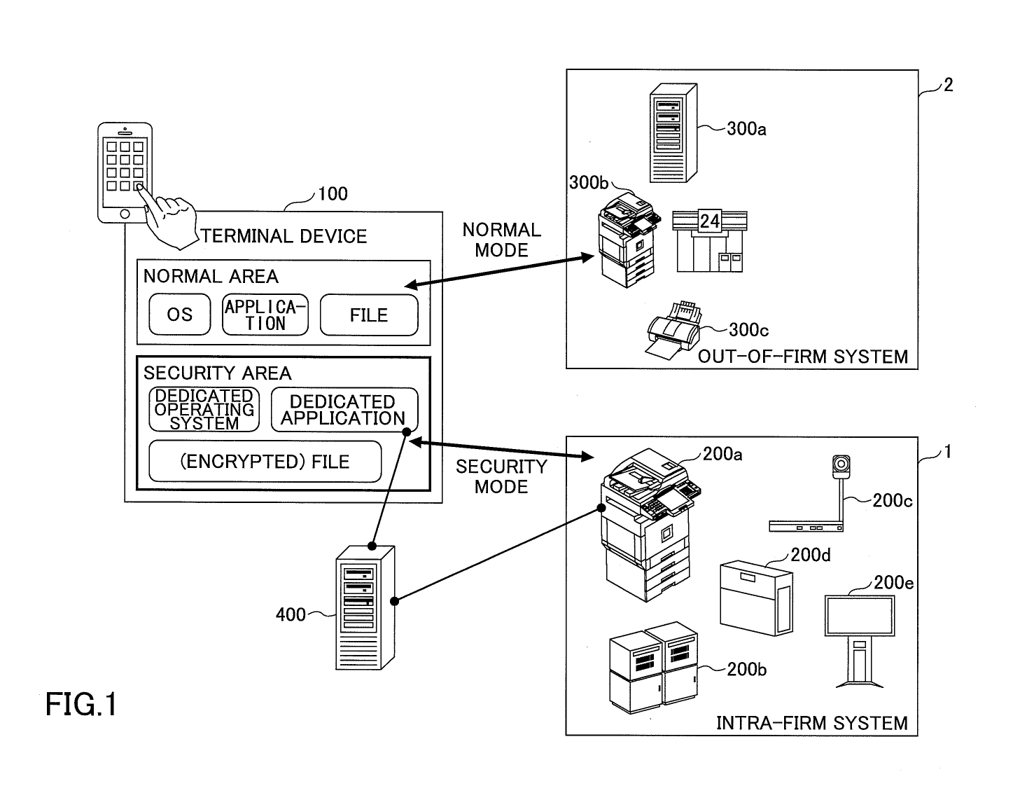

FIG. 1 is a drawing illustrating an example of a configuration of an information processing system which connects a terminal device 100 to equipment at a workplace. An intra-firm system 1 is equipment at the workplace used for job-related purposes, and an out-of-firm system 2 is equipment situated outside the workplace used for personal non-job-related purposes.

Examples of the terminal device 100 are a smartphone, a tablet, a feature phone, a wearable device, etc. The terminal device 100 has an operating system, applications, and files in a normal area, which are used personally outside the workplace, and has a dedicated operating system, dedicated applications, and encrypted files, with enhanced security levels, in a security area. The operating system and applications in the normal area and the operating system and applications in the security area have generally common functions, except for the presence of a security function in the operating system and applications in the security area. The terminal device 100, having the normal mode and the security mode, utilizes the operating system and applications in the normal area during the normal mode, and utilizes the operating system and applications in the security area during the security mode. The terminal device 100 is switched between the normal mode and the security mode by a user operation.

The intra-firm system 1 includes an MFP 200a, a storage server 200b, an UCS (Unified Communication System) 200c, a projector 200d, an electronic blackboard 200e, etc. In the following, each of the apparatuses included in the intra-firm system 1 is referred to as an information processing apparatus 200. The information processing apparatus 200 runs an application having a security function to detect the mode of the terminal device 100 and select an action and a function to be performed based on the detected mode. For example, the information processing apparatus 200 limits the operations that the terminal device 100 can perform when the terminal device 100 is on the normal mode, and does not limit the operations performed by the terminal device 100 when the terminal device 100 is on the security mode.

The out-of-firm system 2 includes a cloud storage server 300a, an MFP 300b in a convenience store, a printer 300c for household use, etc. The terminal device 100 can utilize each of the apparatuses included in the out-of-firm system 2 during the normal mode.

Additionally, applications and encryption methods used in the terminal device 100 and applications used in the information processing apparatus 200 are downloaded through an application server 400 via the Internet, etc.

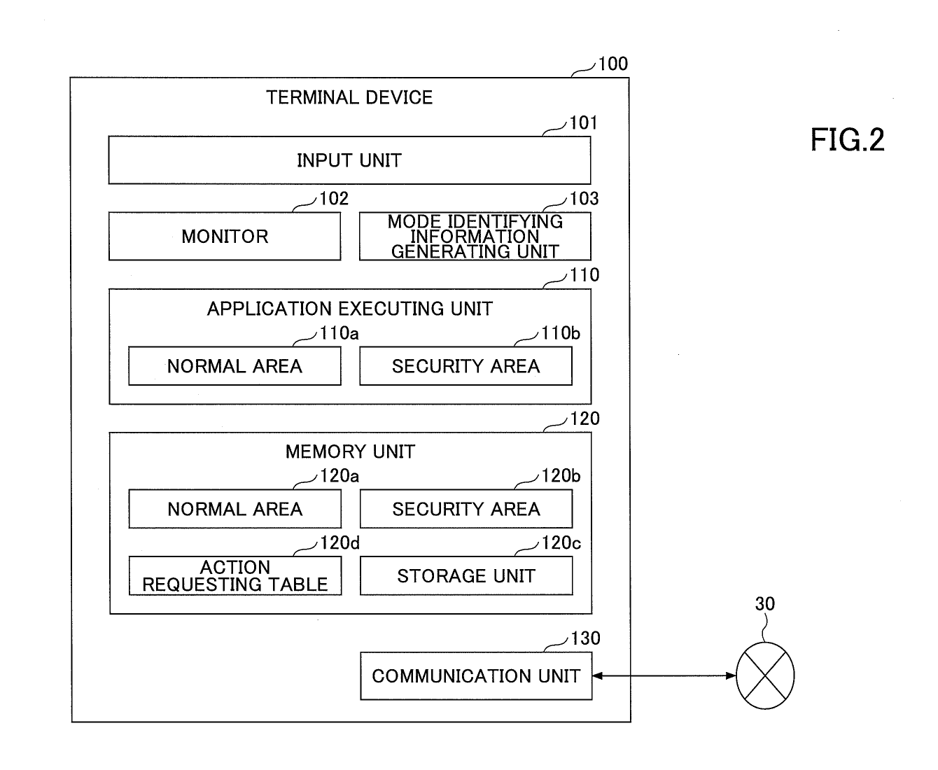

FIG. 2 is a drawing illustrating an example of a functional configuration of the terminal device 100. The terminal device 100 includes an input unit 101, a monitor 102, a mode identifying information generating unit 103, an application executing unit 110, a memory unit 120, and a communication unit 130. The memory unit 120 stores electronic data, applications, and other kinds of data. The memory unit 120 has a normal area 120a and a security area 120b, and data cannot be transferred between the areas. The security area 120b stores data to be used for job-related purposes, etc., and the stored data is encrypted, whereas the normal area 120a stores data to be used for non-job-related purposes.

The input unit 101 detects and interprets signals being input through a numeric keypad, a touch panel, etc., and then produces an instruction to execute functions. For example, the input unit 101 receives input such as an instruction to select and execute the function to run an application and an instruction to switch the mode between the normal mode and the security mode.

The monitor 102 displays a home screen, application icons, messages, and electronic data such as files which are opened by the application executing unit 110.

The mode identifying information generating unit 103 generates mode identifying information for distinguishing between the normal mode and the security mode. For example, the mode identifying information generating unit 103 generates mode identifying information “N” during the normal mode and generates mode identifying information “S” during the security mode. The mode identifying information generating unit 103 stores the generated mode identifying information in a storage unit 120c.

The application executing unit 110 executes applications to view, to edit, and to save electronic data. For example, the application executing unit 110 has applications such as a document viewing and editing application, a printing application, a displaying application for a projector and a displaying device, a mailing application, a facsimile sending and receiving application, an image editing application, a browsing application, and a data encrypting application.

The application executing unit 110 has a normal area 110a and a security area 110b. The normal area 110a and the security area 110b have corresponding applications with equivalent functions, and the applications in the security area 110b have security functions. For example, the application executing unit 110 has an MFP remote controlling application to be used during the normal mode in the normal area 110a, and has an MFP remote controlling application with almost the same function to be used during the security mode in the security area 110b.

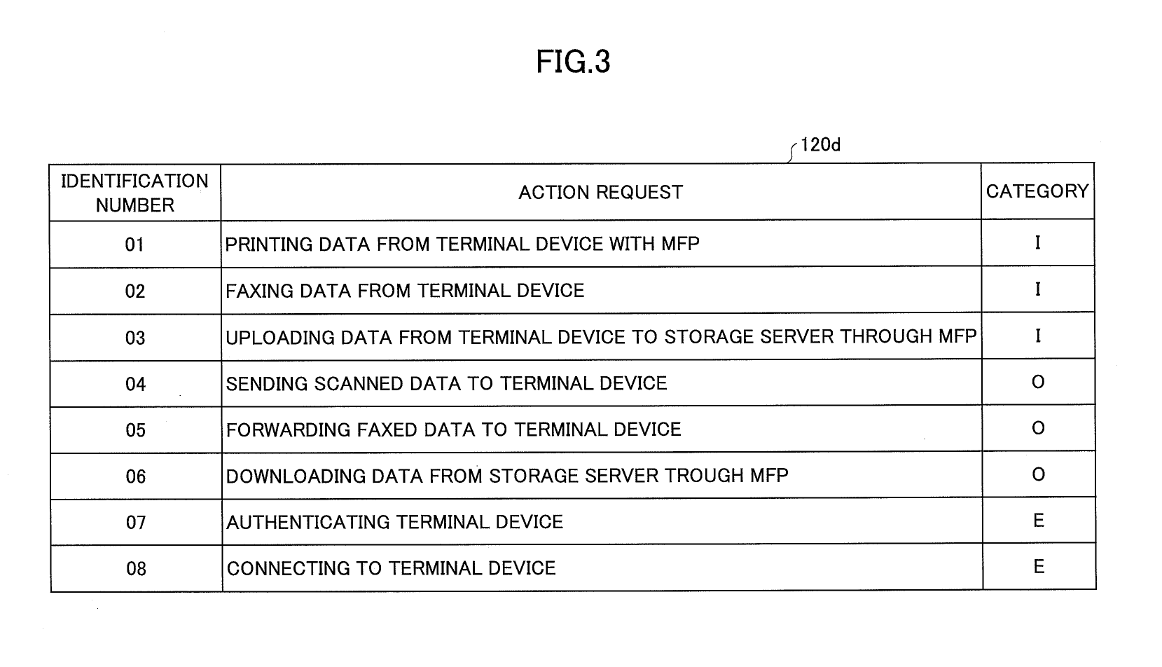

FIG. 3 is a drawing illustrating an example of an action requesting table 120d. In the action requesting table 120d, each action request corresponds to “identification number” (01 through 08). “Action request” indicates an action which the terminal device 100 requests the information processing apparatus 200 to perform. Furthermore, each action request is categorized into one of “I”, “O”, and “E”, which indicate an input of the information processing apparatus 200, an output of the information processing apparatus 200, and others, respectively.

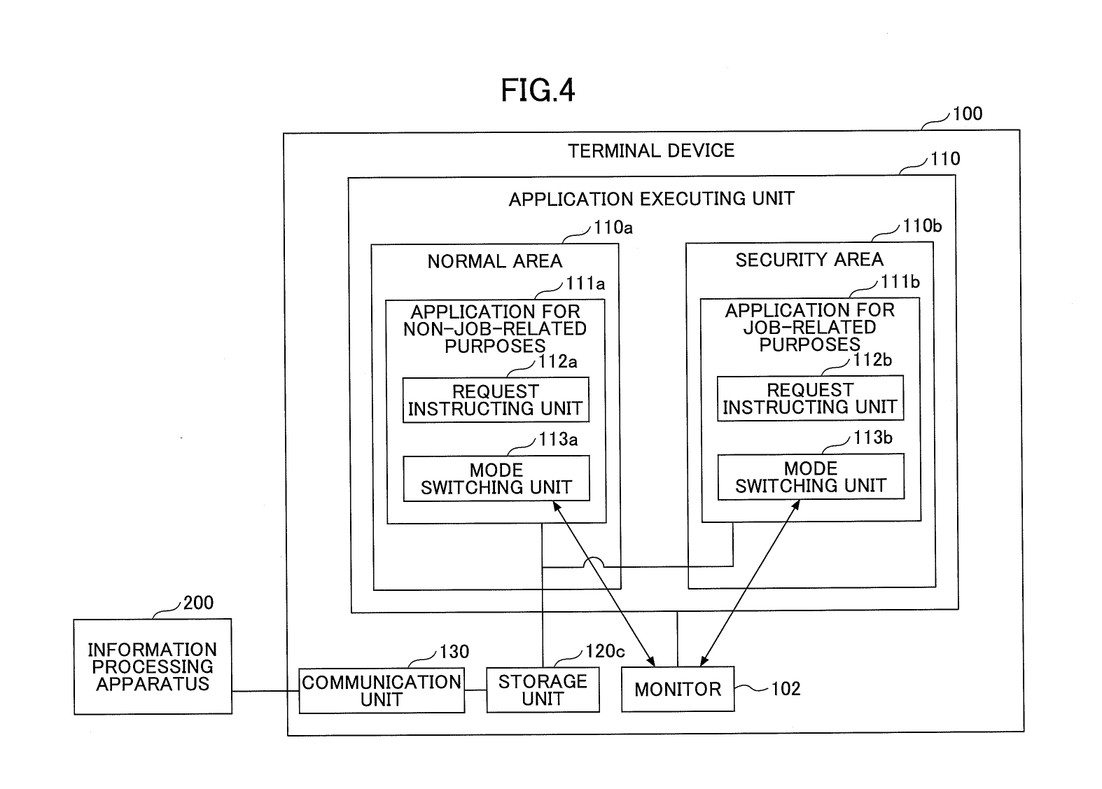

FIG. 4 is a drawing illustrating an example of a functional configuration of the application executing unit 110. The application executing unit 110 has the normal area 110a and the security area 110b. The terminal device 100 has an application 111a for non-job-related purposes which is executed during the normal mode in the normal area 110a, and has an application 111b for job-related purposes which is executed during the security mode in the security area 110b. The application 111a for non-job-related purposes and the application 111b for job-related purposes generate and send action requests such as inputting and outputting, printing, scanning, and faxing to the information processing apparatus 200. The application 111a for non-job-related purposes has a request instructing unit 112a and a mode switching unit 113a. The application 111b for job-related purposes has a request instructing unit 112b and a mode switching unit 113b.

The request instructing unit 112a stores the mode identifying information “N” in the storing unit 120c when an application 111a for non-job-related purposes is executed. Furthermore, the request instructing unit 112b stores the mode identifying information “S” in the storing unit 120c when an application 111b for job-related purposes is executed.

The request instructing unit 112a and the request instructing unit 112b search the action requesting table 120d to find an identification number and a category corresponding to the action request selected by a user, and then store the identification number and the category in the storage unit 120c.

The communication unit 130 sends to the information processing apparatus 200 the mode identifying information, as well as the identification number and the category of the action request, which are stored in the storage unit 120c.

The mode switching unit 113a and the mode switching unit 113b switch the mode between the normal mode and the security mode.

When the communication unit 130 receives a request from the information processing apparatus 200 to switch the mode from the normal mode to the security mode, the mode switching unit 113b displays an instruction to switch the mode on the monitor 102. The mode switching unit 113b switches the mode from the normal mode to the security mode in response to a relevant operation performed by a user on the monitor 102.

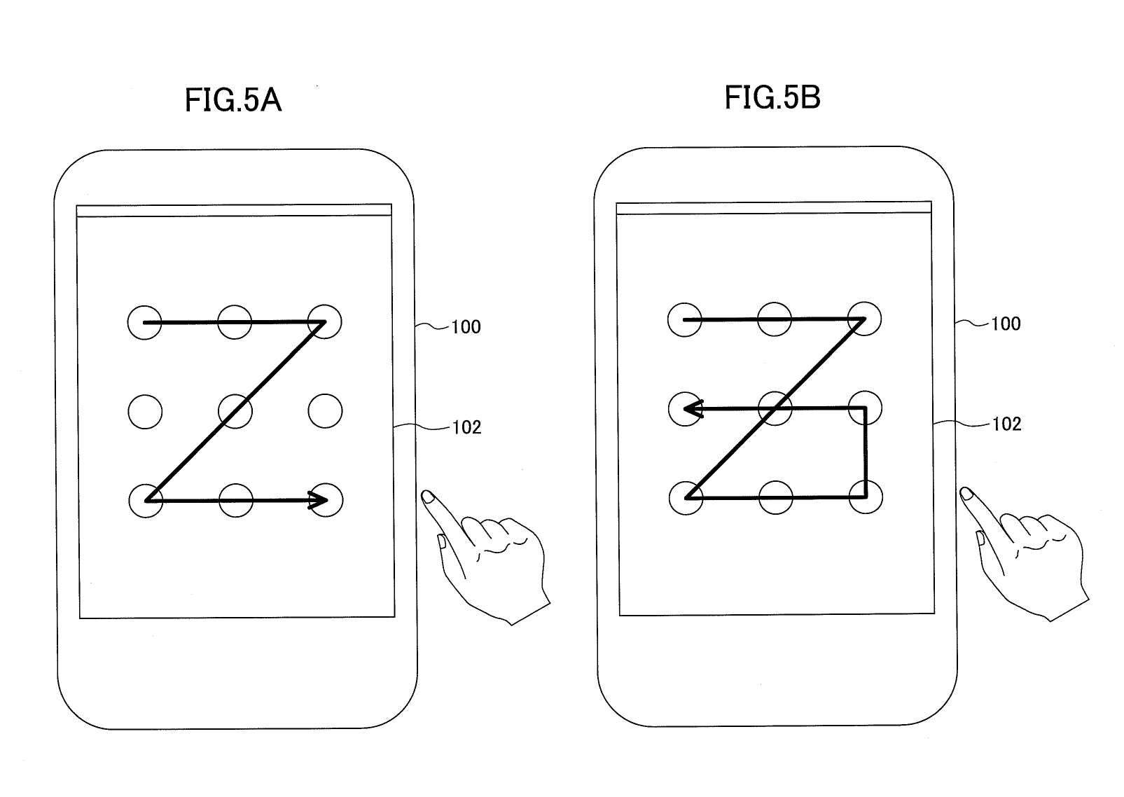

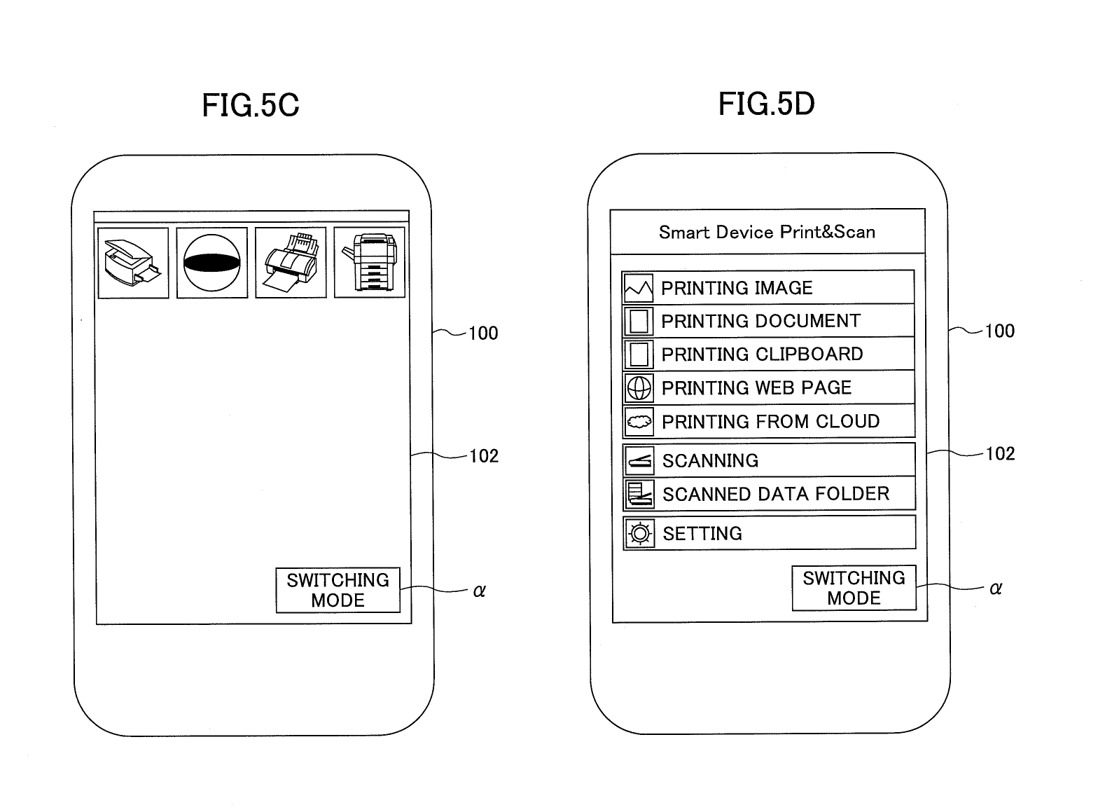

FIGS. 5A and 5B are drawings illustrating a first example of screens to provide an instruction to switch the mode. The mode stitching unit 113b displays lock screens illustrated in FIGS. 5A and 5B on the monitor 102 of the terminal device 100. On the lock screens, nine dots appear. When a user traces the dots with his/her finger in the order illustrated in FIG. 5B, the mode switching unit 113b deactivates the normal mode and activates the security mode. Furthermore, when a user traces the dots with his/her finger in the order illustrated in FIG. 5A, the information processing apparatus 200 activates the normal mode.

The order as illustrated in FIG. 5B for activating the security mode is preferably more complicated than the order as illustrated in FIG. 5A for activating the normal mode, in such ways that a dot has to be traced twice, all the dots have to be traced, etc.

FIGS. 5C and 5D are drawings illustrating a second example of screens to provide an instruction to switch the mode. FIG. 5C illustrates the home screen and FIG. 5D illustrates a screen of an executed application. The mode switching unit 113b displays a mode switching button α on the monitor 102 of the terminal device 100. Both in FIG. 5C and in FIG. 5D, the terminal device 100 switches between the normal mode and the security mode when the mode switching button α is clicked.

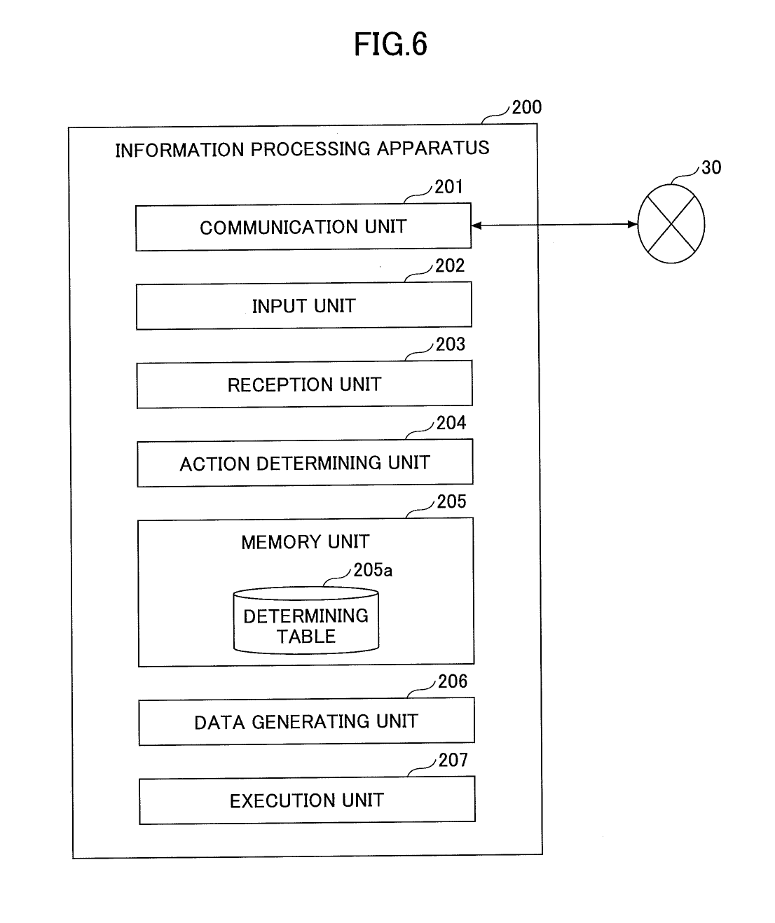

FIG. 6 is a drawing illustrating an example of a functional configuration of the information processing apparatus 200 relating to the first embodiment. The information processing apparatus 200 includes a communication unit 201, an input unit 202, a reception unit 203, an action determining unit 204, a memory unit 205, a data generating unit 206, and an execution unit 207. Furthermore, the memory unit 205 includes a determining table 205a.

The communication unit 201 receives mode identifying information, as well as an identification number and a category of an action request, which are sent from the terminal device 100 through a network 30. Furthermore, the communication unit 201 sends to the terminal device 100 data of an image scanned with an MFP, data received by a facsimile, etc.

The input unit 202 receives instruction data entered into the information processing apparatus 200. The reception unit 203 receives from the terminal device 100 mode identifying information, as well as an identification number and a category of an action request.

The action determining unit 204 determines the mode of the terminal device 100 based on the received mode identifying information. The action determining unit 204 selects an action which corresponds to the action request and the mode of the terminal device 100 based on the determining table 205a in the memory unit 205. For example, in the case of receiving a printing request in the security mode, the action determining unit 204 selects printing, whereas in the case of receiving a printing request in the normal mode, the action determining unit 204 selects the action to send a message to the terminal device 100 in order to instruct the terminal device 100 to switch to the security mode, without performing printing.

The memory unit 205 includes the determining table 205a. The data generating unit 206 generates messages relating to actions or performance results of the information processing apparatus 200. The execution unit 207 executes an action that the action determining unit 204 determines to perform.

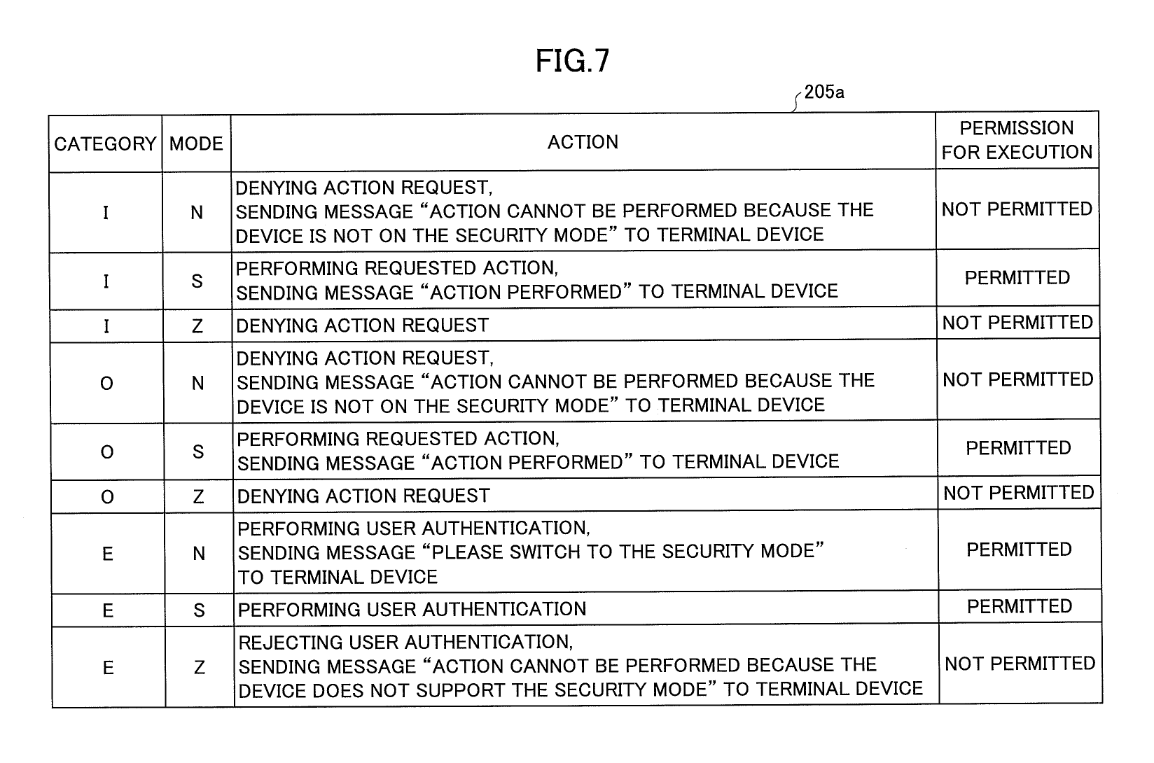

FIG. 7 is a drawing illustrating an example of the determining table 205a. The determining table 205a has entries indicative of actions performed by the information processing apparatus 200 on a category-and-mode-specific basis. “Category” corresponds to “category” of the action requesting table 120d in FIG. 3. “I”, “O” and “E” indicate an input of the information processing apparatus 200, an output of the information processing apparatus 200, and others, respectively. “Mode” indicates the mode of the terminal device 100 which is determined based on the mode identifying information. “N” and “S” indicate the normal mode and the security mode, respectively. “Z” indicates that an action request is sent from a device with no mode setting function. For example, in the case that data sent from a terminal device do not include mode identifying information, the data are determined to be “Z”.

“Action” indicates an action to be performed by the information processing apparatus 200. For example, in the case that the category of an action request is “I” and the mode identifying information is “N”, the information processing apparatus 200 denies the action request and sends to the terminal device 100 the message “action cannot be performed because the device is not on the security mode”. Furthermore, in the case that the category of an action request is “I” and the mode identifying information is “S”, the information processing apparatus 200 performs the requested action and sends to the terminal device 100 the message “action performed”. Moreover, in the case that the category of an action request is “I” and the mode identifying information is “Z”, the information processing apparatus 200 denies the action request.

“Permission for execution” indicates whether or not the information processing apparatus 200 performs an action requested by a user.

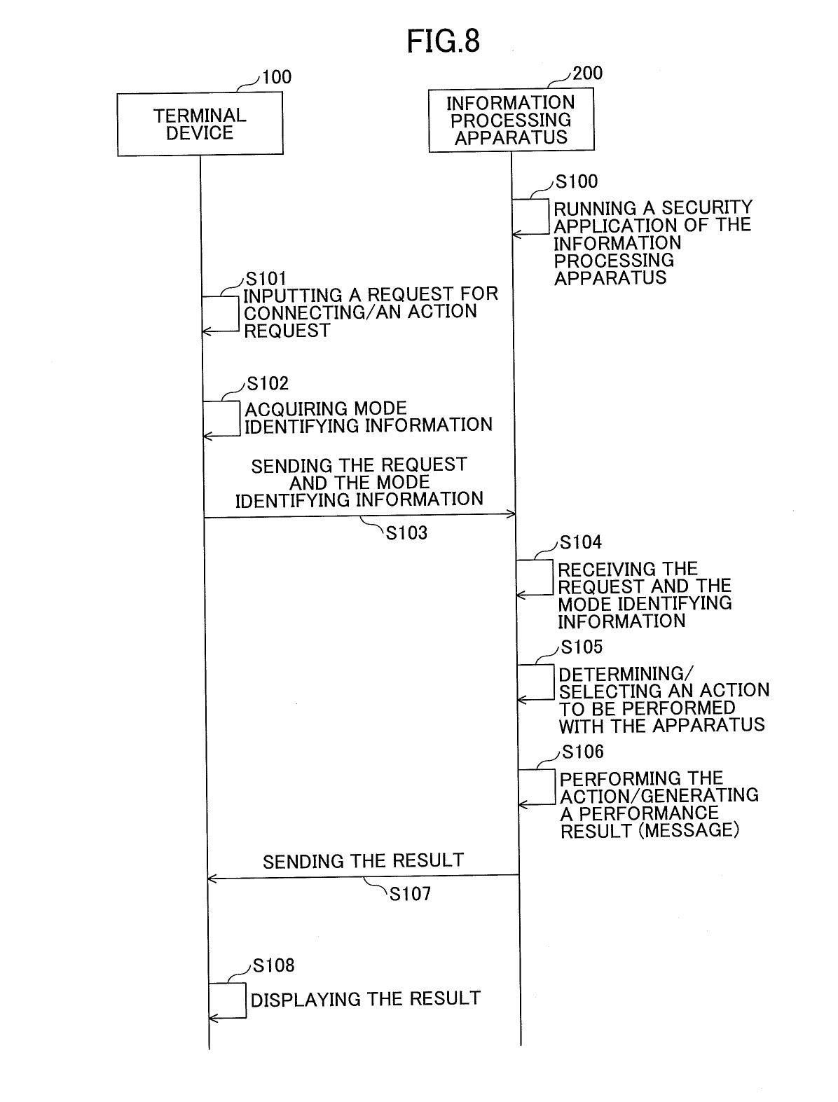

FIG. 8 is a drawing illustrating a processing sequence in the terminal device 100 and the information processing apparatus 200 relating to the first embodiment. The information processing apparatus 200 runs a security application (step S100).

The input unit 101 of the terminal device 100 receives a processing request to be sent to the information processing apparatus 200 (step S101). For example, the terminal device 100 opens a document using a printing application included in the application executing unit 110, and then generates identification number “01” and category “I” which correspond to a printing instruction. Subsequently, the terminal device 100 acquires the mode identifying information from the storage unit 120c (step S102). The terminal device 100 sends to the information processing apparatus 200 through the communication unit 130 the identification number and the category of the action request, as well as the mode identifying information (step S103).

The information processing apparatus 200 receives the identification number and the category of the action request, as well as the mode identifying information (step S104).

The information processing apparatus 200 refers to the determining table 205a to select an action that corresponds to the category of the action request and the mode identifying information (step S105). For example, in the case of receiving a scanning request (category “O”) when the terminal device 100 is on the normal mode, the information processing apparatus 200 denies the action request and sends to the terminal device 100 the message “action cannot be performed because the device is not on the security mode”. Furthermore, in the case of receiving a scanning request when the terminal device 100 is on the security mode, the information processing apparatus 200 determines to perform the requested action and sends to the terminal device 100 the message “action performed”.

The information processing apparatus 200 performs an action which corresponds to the identification number of an action request. The data generating unit 206 generates a message relating to a performance result (step S106), and then sends the message to the terminal device 100 (step S107). The message is displayed on the monitor 102 of the terminal device 100 (step S108). As an example of the message relating to a performance result, “action cannot be performed because the device is not on the security mode”, “action performed”, etc., is displayed.

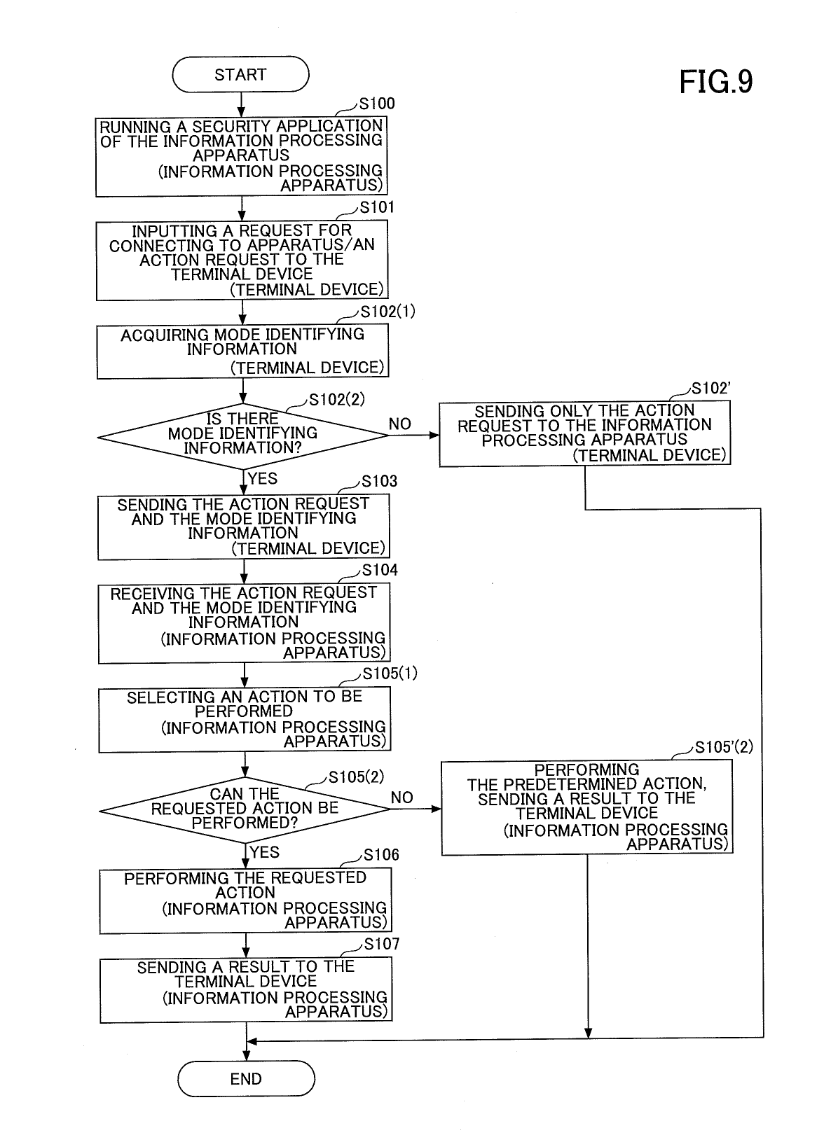

FIG. 9 is a drawing illustrating a flowchart of a process performed between the terminal device 100 and the information processing apparatus 200 relating to the first embodiment. The information processing apparatus 200 runs a security application (step S100).

The terminal device 100 receives a processing request to be sent to the information processing apparatus 200 (step S101). Subsequently, the terminal device 100 acquires mode identifying information from the storage unit 120c (step S102 (1)). The terminal device 100 determines whether mode identifying information is stored in the storage unit 120c (step S102 (2)). In the case that mode identifying information is stored in the storage unit 120c (step S102 (2) YES), the terminal device 100 proceeds to the process of step S103. On the other hand, in the case that mode identifying information is not stored in the storage unit 120c (step S102 (2) NO), the terminal device 100 proceeds to the process of step S102′.

In the step 102′, the terminal device 100 sends to the information processing apparatus 200 only the identification number and the category of the action request, and then terminates the process.

In the step 103, the terminal device 100 sends to the information processing apparatus 200 through the communication unit 130 the identification number and the category of the action request, as well as the mode identifying number.

The information processing apparatus 200 acquires the identification number and the category of the action request, as well as the mode identifying information (step S104). The information processing apparatus 200 refers to the determining table 205a, and then selects an action based on the identification number and the category of the action request, as well as the mode identifying information (step S105 (1)). The action determining unit 204 determines whether the requested action can be performed (step S105 (2)). In the case that the requested action can be performed (step S105 (2) YES), the action determining unit 204 performs the requested action (step S106), and then sends the performance result to the terminal device 100 (step S107). On the other hand, in the case that the requested action cannot be performed (step S105 (2) NO), the action determining unit 204 performs a predetermined action such as denying the action request, and then sends the performance result to the terminal device 100 (step S105′ (2)).

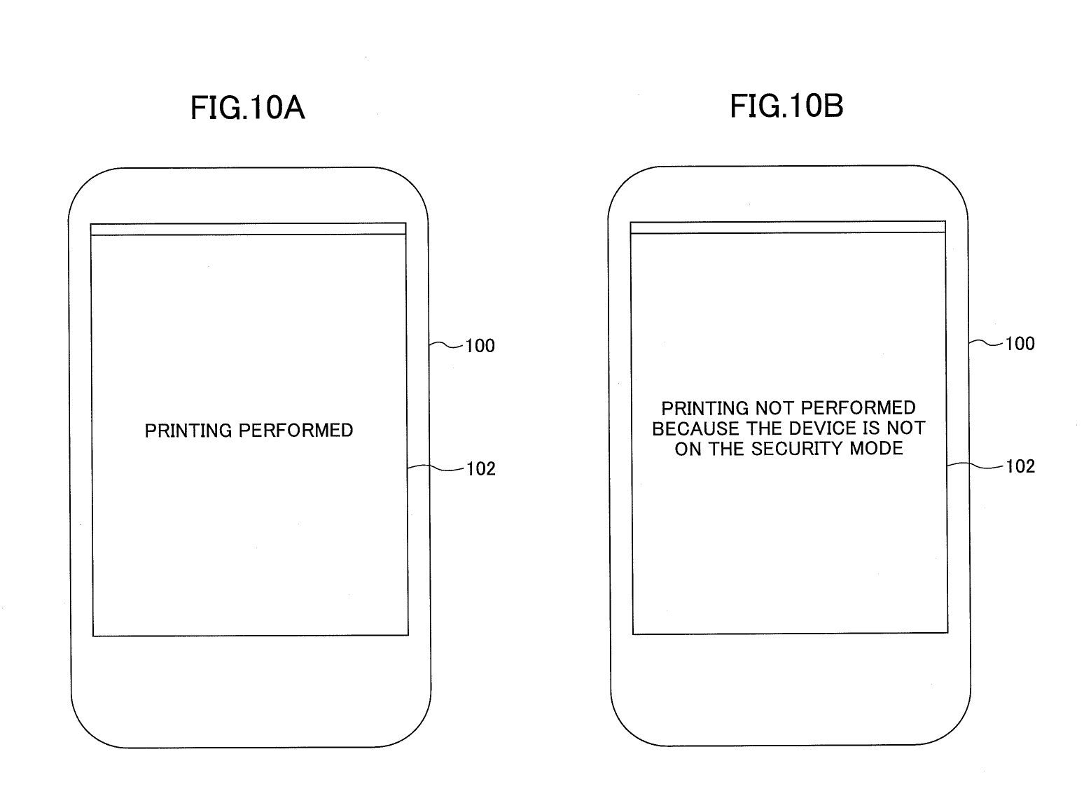

FIGS. 10A and 10B are drawings illustrating examples of a displayed performance result sent to the terminal device 100. FIG. 10A indicates the case where a requested printing action is performed and a pop-up of “printing performed” appears on the monitor 102 as a performance result. Furthermore, FIG. 10B indicates the case where a requested printing action is not performed and a pop-up of “printing not performed because the device is not on the security mode” appears on the monitor 102.

### Second Embodiment

A description of the configuration of the terminal device 100 is omitted in the second embodiment because the configuration of the terminal device 100 is the same as previously described.

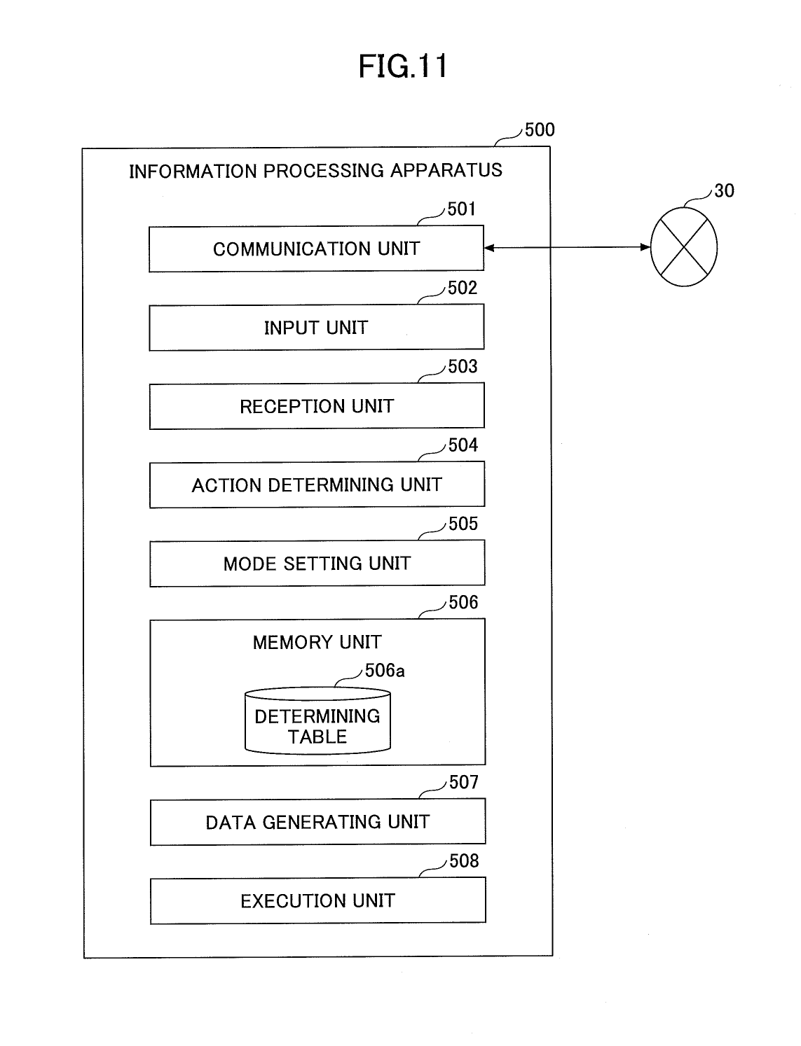

FIG. 11 is a drawing illustrating an example of a functional configuration of an information processing apparatus 500 relating to the second embodiment. The information processing apparatus 500 includes a communication unit 501, an input unit 502, a reception unit 503, an action determining unit 504, a mode setting unit 505, a memory unit 506, a data generating unit 507, and an execution unit 508. Furthermore, the memory unit 506 includes a determining table 506a.

The communication unit 501 receives from the terminal device 100 through the network 30 mode identifying information, as well as a category and an identification number of an action request. Furthermore, the communication unit 501 sends scanned image data and received facsimile data to the terminal device 100.

The input unit 502 receives instruction data entered into the information processing apparatus 500. The reception unit 503 receives the mode identifying information, as well as the category and the identification number of the action request, which are sent from the terminal device 100.

The action determining unit 504 determines the mode of the terminal device 100 based on the received mode identifying information. The action determining unit 504 selects an action which corresponds to the action request and the mode of the terminal device 100, based on the determining table 506a stored in the memory unit 506.

The memory unit 506 includes the determining table 506a. The data generating unit 507 generates a message relating to the performance result of a performed action. The execution unit 508 executes an action that is selected by the action determining unit 504.

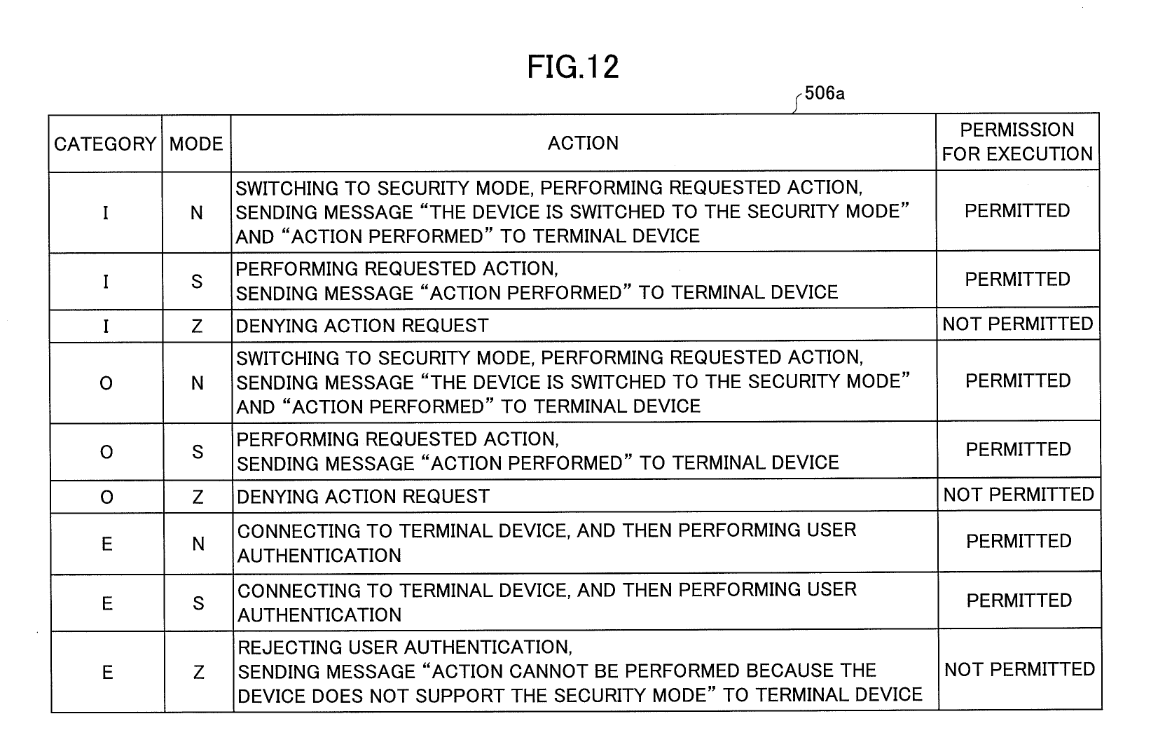

FIG. 12 is a drawing illustrating an example of the determining table 506a. The determining table 506a has entries indicative of actions on a category-and-mode-specific basis. “Category” corresponds to “category” of the action requesting table 120d in FIG. 3, and “I”, “O” and “E” indicate an input of the information processing apparatus 500, an output of the information processing apparatus 500, and others, respectively. “Mode” indicates the mode of the terminal device 100 which is determined based on the mode identifying information. “N” and “S” indicate the normal mode and the security mode, respectively. “Z” indicates that an action request is sent from a device with no mode setting function. For example, in the case that data sent from a terminal device do not include mode identifying information, the data are determined to be “Z”.

“Action” indicates an action to be performed by the information processing apparatus 500. For example, in the case that the category of an action request is “I” and the mode identifying information is “N”, the action determining unit 504 determines to send an operation to switch the mode of the terminal device 100 to the security mode. Subsequently, the information processing apparatus 500 sends to the terminal device 100 the message “the device is switched to the security mode”. After the mode of the terminal device 100 is switched, the information processing apparatus 500 performs the requested action and sends to the terminal device 100 the message “action performed”. Furthermore, in the case that that the category of an action request is “I” and the mode identifying information is “S”, the information processing apparatus 500 performs the requested action and sends to the terminal device 100 the message “action performed”. Moreover, in the case that the category of an action request is “I” and the mode identifying information is “Z”, the information processing apparatus 500 denies the action request.

Furthermore, in the case that the category of the action request is “O” and the mode identifying information is “N”, the action determining unit 504 switches the mode of the terminal device 100 to the security mode. Subsequently, the information processing apparatus 500 sends to the terminal device 100 the message “the device is switched to the security mode”. After the mode of the terminal device 100 is switched, the information processing apparatus 500 performs the requested action and sends to the terminal device 100 the message “action performed”. Moreover, in the case that the category of the action request is “O” and the mode identifying information is “S”, the information processing apparatus 500 performs the requested action and sends to the terminal device 100 the message “action performed”. Furthermore, in the case that the category of the action request is “O” and the mode identifying information is “Z”, the information processing apparatus 500 denies the action request.

Furthermore, in the case that the category of the action request is “E” and the mode identifying information is “N” or “S”, the information processing apparatus 500 is connected to the terminal device 100, and then performs a user authentication. Moreover, in the case that the category of the action request is “E” and the mode identifying information is “Z”, the information processing apparatus 500 rejects a user authentication, and then sends to the terminal device 100 the message “action cannot be performed because the device does not support the security mode”.

Additionally, although it has been described that, in the case that the category of the action request is “I” or “O” and the mode identifying information is “N”, the action determining unit 504 switches the mode of the terminal device 100 to the security mode using the mode setting unit 505, the scope of the invention is not limited to the case as described. For example, in the case that the category of the action request is “E” and the mode identifying information is “N”, the information processing apparatus 500 may switch the mode of the terminal device 100 to the security mode, that is, may switch the mode of the terminal device 100 during a user authentication.

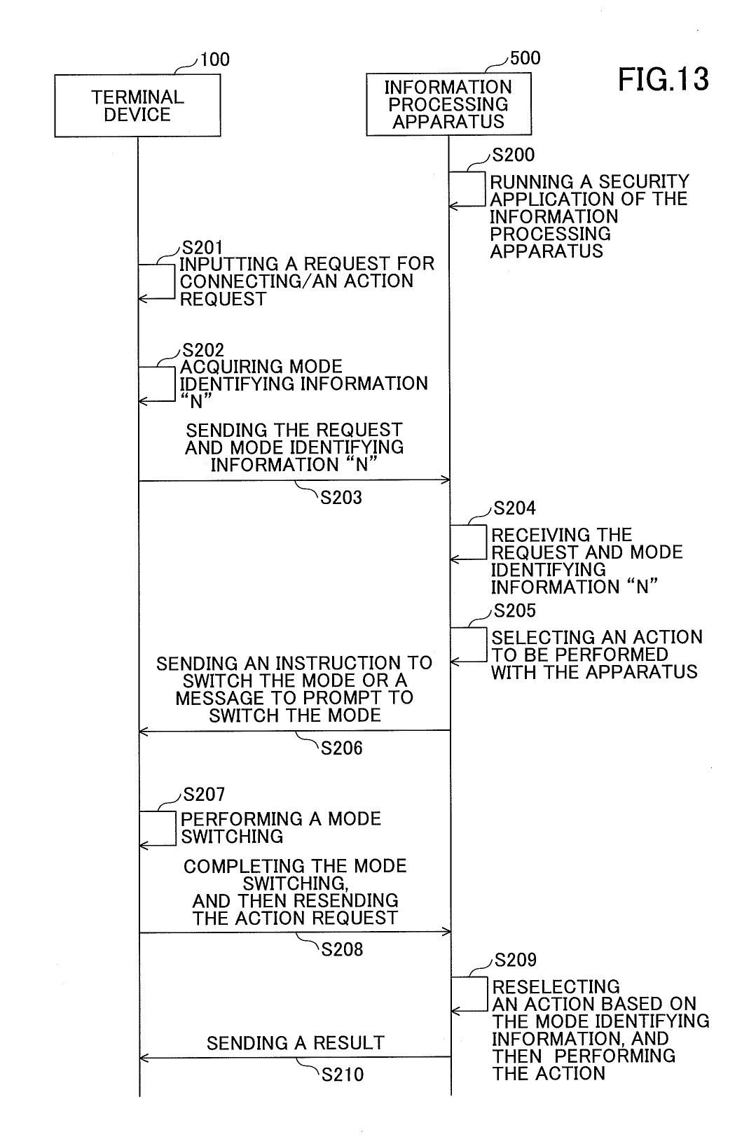

FIG. 13 is a drawing illustrating a processing sequence in the terminal device 100 and the information processing apparatus 500 relating to the second embodiment. The information processing apparatus 500 runs a security application (step S200).

The terminal device 100 receives a processing request to be sent to the information processing apparatus 500 (step S201). Subsequently, the terminal device 100 acquires the mode identifying information “N” (normal mode) from the storage unit 120c (step S202). The terminal device 100 sends to the information processing apparatus 500 through the communication unit 130 an identification number and a category of an action request, as well as the mode identifying information “N” (step S203).

The information processing apparatus 500 receives the identification number and the category of the action request, as well as the mode identifying information “N” (step S204). The processing apparatus 500 refers to the determining table 506a, and then selects an action that corresponds to the category and the identification number of the action request, as well as the mode identifying information (step S205). The information processing apparatus 500 sends to the terminal device 100 an instruction to switch the mode or a message to prompt to switch the mode (step S206). The terminal device 100 performs switching the mode (step S207). The terminal device 100 sends to the information processing apparatus 500 through the communication unit 130 the identification number and the category of the action request, as well as the mode identifying information “S” (step S208). The information processing apparatus 500 reselects an action that corresponds to the received category and identification number of the action request, as well as the mode identifying information, and then performs the action that corresponds to the identification number of the action request (step S209). The data generating unit 206 generates a message relating to a performance result, and then sends the message to the terminal device 100 (step S210).

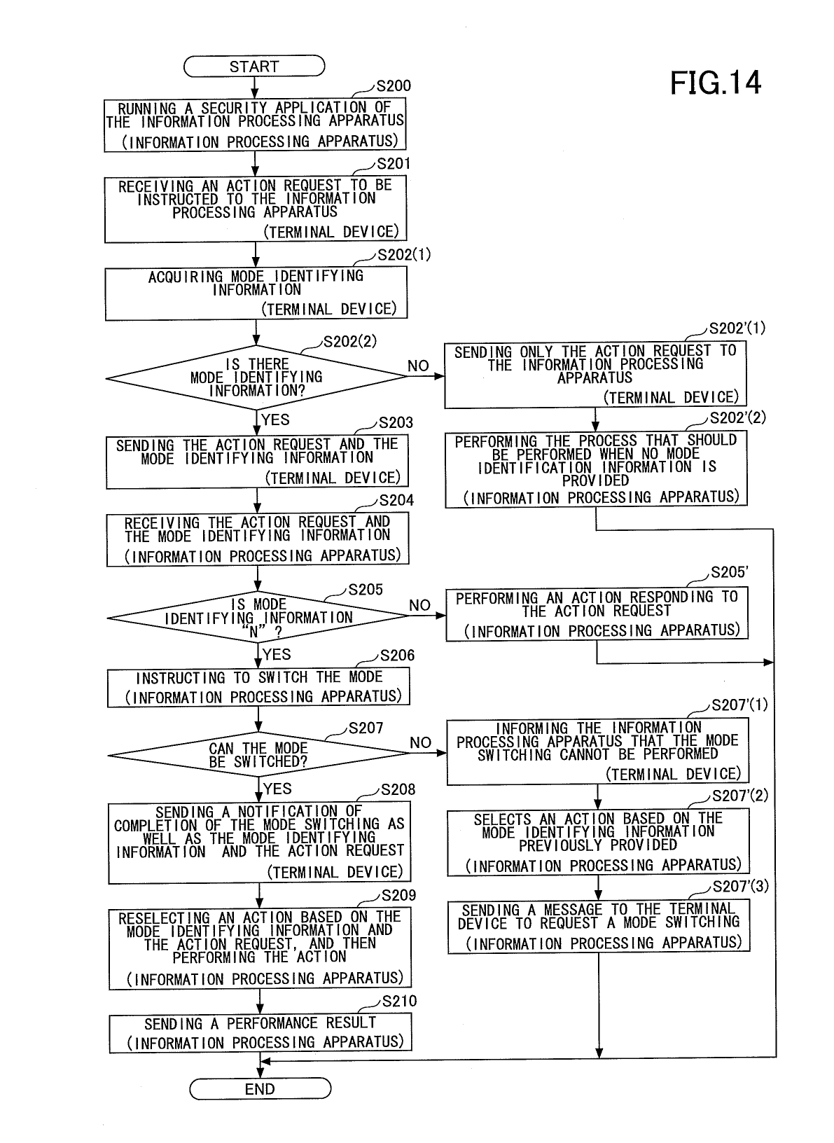

FIG. 14 is a drawing illustrating a flowchart of a process performed between the terminal device 100 and the information processing apparatus 500 relating to the second embodiment. The information processing apparatus 500 runs a security application (step S200).

The terminal device 100 receives an action request to be sent to the information processing apparatus 500 (step S201). Subsequently, the terminal device 100 acquires mode identifying information from the storage unit 120c (step S202 (1)). The terminal device 100 determines whether mode identifying information is stored in the storage unit 120c (step S202 (2)). In the case that mode identifying information is stored (step S202 (2) YES), the terminal device 100 proceeds to the process of step S203, while in the case that mode identifying information is not stored (step S202 (2) NO), the terminal device 100 proceeds to the process of step S202′ (1).

In the step 202′ (1), the terminal device 100 sends only the action request to the information processing apparatus 500. The information processing apparatus 500 performs the process that should be performed when no mode identification information is provided (step S202′ (2)), and then terminates the process. For example, the information processing apparatus 500 sends to the terminal device 100 the message “action cannot be performed because the device does not support the security mode”.

In the step S203, the terminal device 100 sends to the information processing apparatus 500 through the communication unit 130 the identification number and the category of the action request, as well as the mode identifying information. The information processing apparatus 500 receives the identification number and the category of the action request, as well as the mode identifying information (step S204). The information processing apparatus 500 determines whether the mode identifying information is “N” (normal mode) (step S205). In the case that the mode identifying information is “S” (step S205 No), the information processing apparatus 500 performs the action that responds to the action request (step S205′), and then terminates the process.

In the case that the mode identifying information is “N” (step S205 YES), the information processing apparatus 500 sends to the terminal device 100 an instruction to switch the mode (step S206).

The terminal device 100 determines whether the mode switching can be performed (step S207). In the case that the mode switching cannot be performed (step S207 No), the terminal device 100 informs the information processing apparatus 500 that the mode switching cannot be performed (step S207′ (1)). Subsequently, the information processing apparatus 500 selects an action based on the mode identifying information previously provided (step S207′ (2)). Subsequently, the information processing apparatus 500 sends to the terminal device 100 a message to prompt to switch the mode such as “please switch to the security mode” (step S207′ (3)).

In the step S207, in the case that the mode switching can be performed (step S207 YES), the terminal device 100 notifies the information processing apparatus 500 that the mode switching is completed and sends to the information processing apparatus 500 the mode identifying information “S”, as well as the category and the identification number of the action request (step S208).

The information processing apparatus 500 reselects an action that corresponds to the mode identifying information, as well as the category and the identification number of the action request, and then performs the action (step S209). The information processing apparatus 500 sends a performance result to the terminal device 100 (step S210). For example, the information processing apparatus 500 sends to the terminal device 100 a performance result “action performed”.

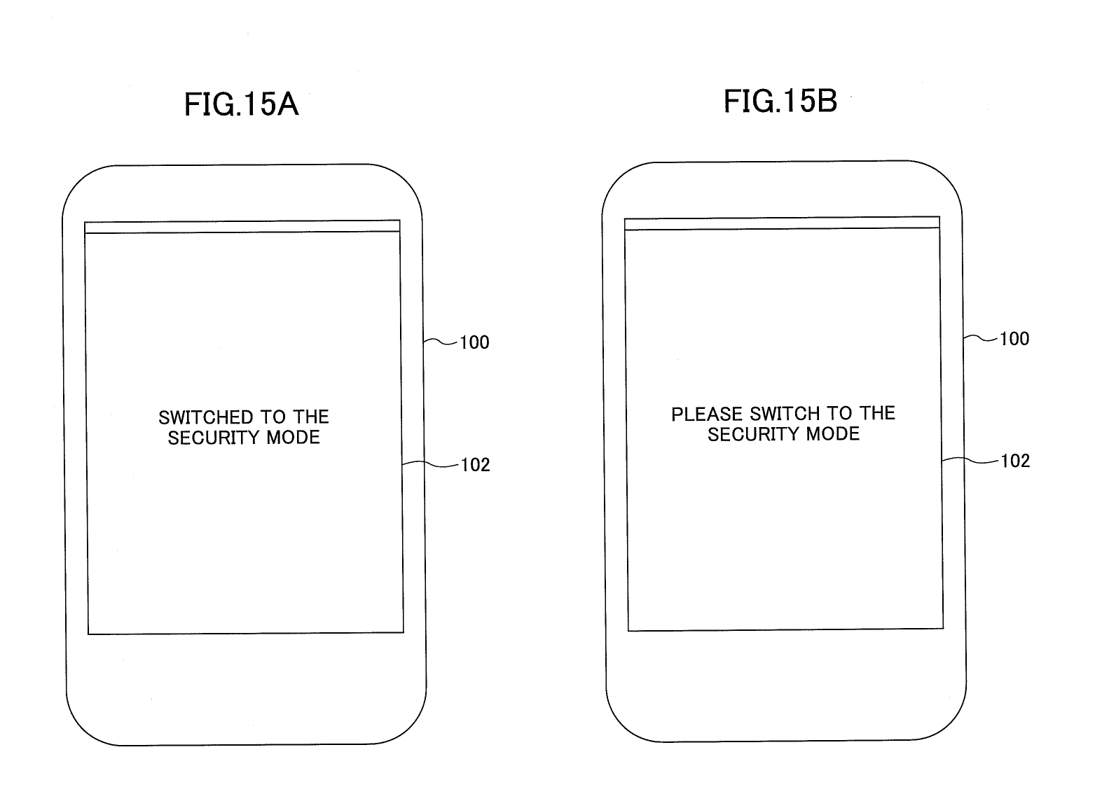

FIGS. 15A and 15B are drawings illustrating examples of a display relating to a mode switching of the terminal device 100. FIG. 15A indicates the case where a mode switching is performed by the information processing apparatus 500 and a pop-up of “switched to the security mode” appears on the monitor 102. Furthermore, FIG. 15B indicates the case where a message to prompt to switch the mode is sent by the information processing apparatus 500 and a pop-up of “please switch to the security mode” appears on the monitor 102.

### Third Embodiment

A description of the configuration of the terminal device 100 is omitted in the third embodiment because the configuration of the terminal device 100 is the same as previously described.

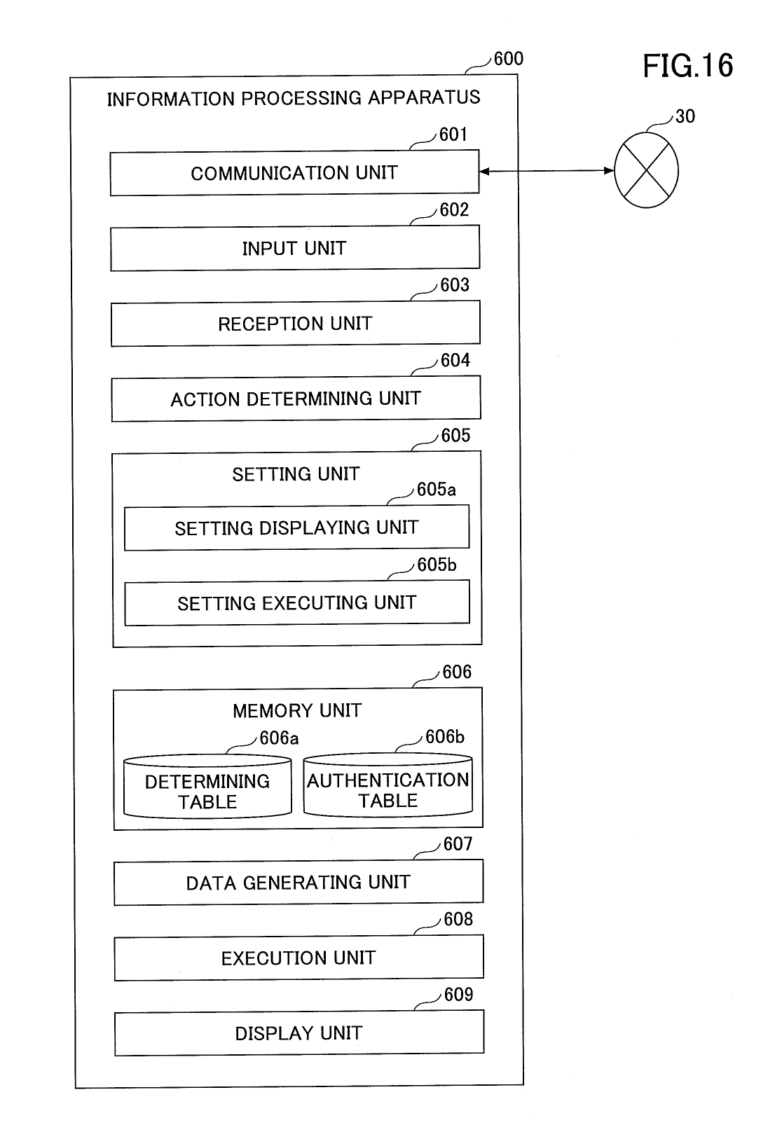

FIG. 16 is a drawing illustrating an example of a functional configuration of an information processing apparatus 600 relating to the third embodiment. The information processing apparatus 600 includes a communication unit 601, an input unit 602, a reception unit 603, an action determining unit 604, a setting unit 605, a memory unit 606, a data generating unit 607, an execution unit 608, and a display unit 609. Furthermore, the mode setting unit 605 includes a setting displaying unit 605a and a setting executing unit 605b. Moreover, the memory unit 606 includes a determining table 606a and an authentication table 606b.

The communication unit 601 receives from the terminal device 100 through the network 30 mode identifying information, as well as a category and an identification number of an action request. Furthermore, the communication unit 601 sends scanned image data and received facsimile data to the terminal device 100.

The input unit 602 receives instruction data entered into the information processing apparatus 600. The reception unit 603 receives from the terminal device 100 the mode identifying information, as well as the category and the identification number of the action request.

The action determining unit 604 determines the mode of the terminal device 100 based on the received mode identifying information. The action determining unit 604 selects an action which corresponds to the category and the identification number of the action request, as well as the mode of the terminal device 100, based on the determining table 606a.

The setting unit 605 includes a setting displaying unit 605a which displays a setting of the information processing apparatus 600 and a setting executing unit 605b which executes a setting of the information processing apparatus 600. For example, the setting displaying unit 605a displays an authentication screen on the display unit 609. Subsequently, for a user with an administrator authority, the setting displaying unit 605a displays on the display unit 609a a setting screen to set up a permission for execution relating to an action request to be input when the terminal device 100 is on the normal mode. The setting executing unit 605b modifies the determining table 606a according to the setting which is input on the setting screen.

The memory unit 606 includes the determining table 606a and the authentication table 606b to be used for a user authentication.

The data generating unit 607 generates a message relating to a performance result of the information processing apparatus 600.

The execution unit 608 executes an action which the action determining unit 604 determines to perform. For example, the execution unit 608 compares a staff number and a password which are input by a user when the user logs in with the authentication table 606b, and thereby performs a user authentication.

The display unit 609 displays a setting screen for a user with an administrator authority to set up a permission for execution relating to an action request to be input when the terminal device 100 is on the normal mode.

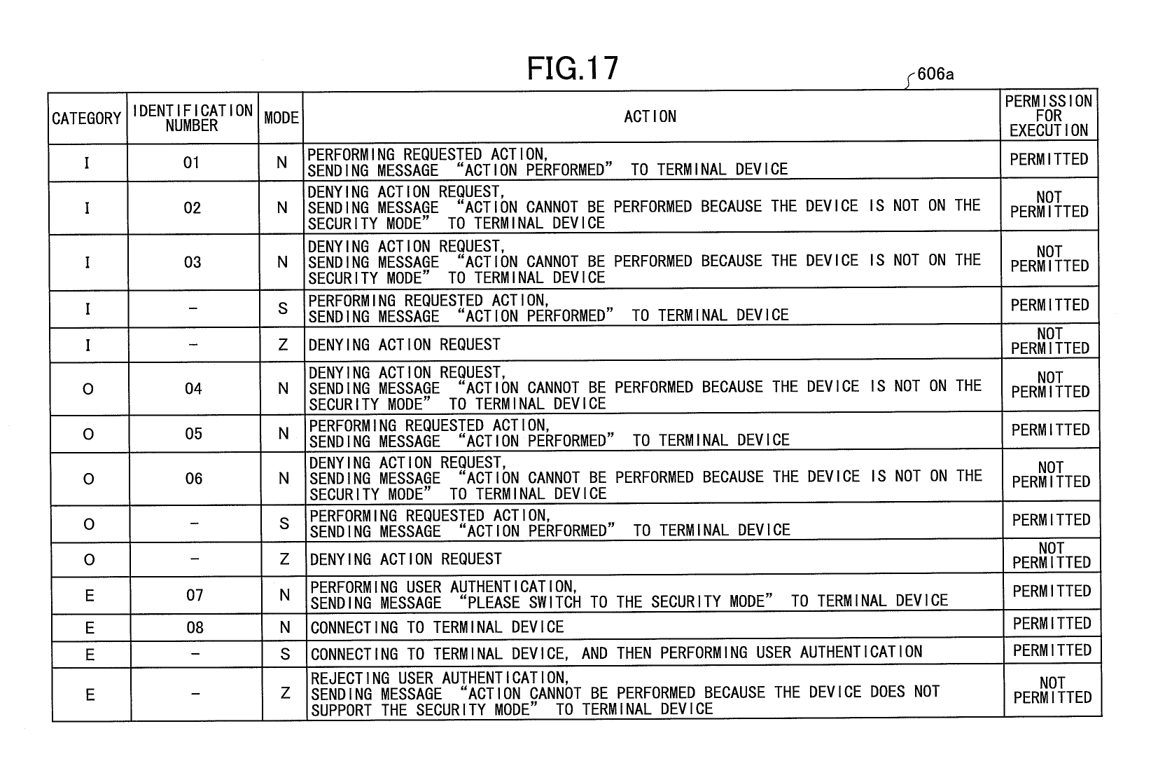

FIG. 17 is a drawing illustrating an example of the determining table 606a. The determining table 606a has entries indicative of actions separately for each identification number and each category of the action request, as well as for each mode. “Category” corresponds to “category” of the action requesting table 120d in FIG. 3, and “I”, “O” and “E” indicate an input of the information processing apparatus 600, an output of the information processing apparatus 600, and others, respectively. “Identification number” indicates identification numbers of action requests and corresponds to the identification numbers of the action requesting table 120d in FIG. 3. “Mode” indicates the mode of the terminal device 100 which is determined based on the mode identifying information. “N” and “S” indicate the normal mode and the security mode, respectively. “Z” indicates that an action request is sent from a device with no mode setting function. “Action” indicates an action to be performed by the information processing apparatus 600.

For example, in the case that the identification number of an action request is “01” and the mode identifying information is “N”, the information processing apparatus 600 performs the requested action and sends to the terminal device 100 the message “action performed”. Furthermore, in the case that the identification number of an action request is “02” and the mode identifying information is “N”, the information processing apparatus 600 denies the requested action and sends to the terminal device 100 the message “action cannot be performed because the device is not on the security mode”. Furthermore, in the case that the identification number of an action request is “03” and the mode identifying information is “N”, the information processing apparatus 600 denies the requested action and sends to the terminal device 100 the message “action cannot be performed because the device is not on the security mode”. Furthermore, in the case that the category of the identification number of an action request is “I” and the mode identifying information is “S”, the information processing apparatus 600 performs the requested action and sends to the terminal device 100 the message “action performed”. Furthermore, in the case that the category of the identification number of an action request is “I” and the mode identifying information is “Z”, the information processing apparatus 600 denies the action request.

Furthermore, in the case that the identification number of an action request is “04” and the mode identifying information is “N”, the information processing apparatus 600 denies the requested action and sends to the terminal device 100 the message “action cannot be performed because the device is not on the security mode”. Furthermore, in the case that the identification number of an action request is “05” and the mode identifying information is “N”, the information processing apparatus 600 performs the requested action and sends to the terminal device 100 the message “action performed”. Furthermore, in the case that the identification number of an action request is “06” and the mode identifying information is “N”, the information processing apparatus 600 denies the requested action and sends to the terminal device 100 the message “action cannot be performed because the device is not on the security mode”.

Furthermore, in the case that the identification number of an action request is “07” and the mode identifying information is “N”, the information processing apparatus 600 performs a user authentication and sends to the terminal device 100 the message “please switch to the security mode”. Furthermore, in the case that the identification number of an action request is “08” and the mode identifying information is “N”, the information processing apparatus 600 is connected to the terminal device. Furthermore, in the case that the category of the identification number of an action request is “E” and the mode identifying information is “S”, the information processing apparatus 600 is connected to the terminal device and performs a user authentication based on the authentication table 606b. Furthermore, in the case that the category of the identification number of an action request is “E” and the mode identifying information is “Z”, the information processing apparatus 600 rejects a user authentication and sends to the terminal device 100 the message “action cannot be performed because the device does not support the security mode”.

That is to say, contrary to the first embodiment, the information processing apparatus 600 permits some of the requested actions even in a case of receiving an identification number of an action request from the terminal device that is on the normal mode. Furthermore, the permission to execute each requested action may be modified by a user with an administrator authority each time the information processing apparatus 600 receives an action request.

“Permission for execution” indicates whether or not the information processing apparatus 600 performs an action requested by a user.

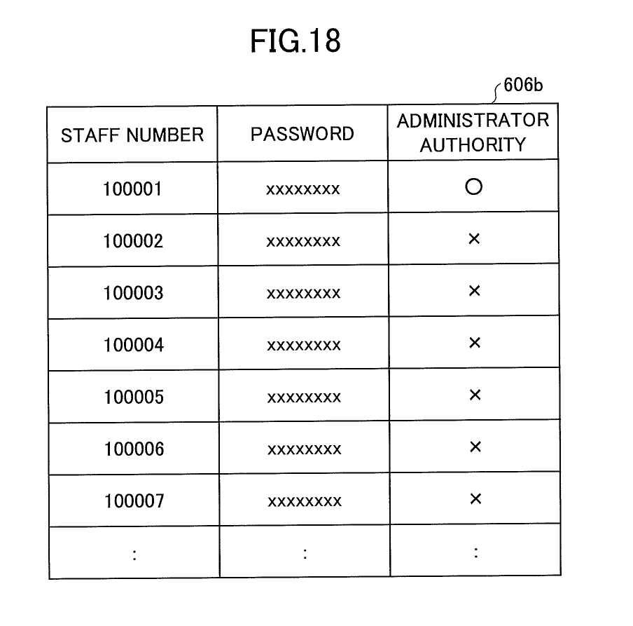

FIG. 18 is a drawing illustrating an example of the authentication table 606b. The authentication table is used for a user authentication. “Staff number” is a number for identifying a user who belongs to the intra-firm system 1. “Password” is a password that a user sets up at the time of a user registration. “Administrator authority” indicates whether or not a user has an administrator authority to perform settings of the information processing apparatus 600.

The information processing apparatus 600 displays on the terminal device 100 a format to be used for a user log in. After a user enters a staff number and a password on the log-in format, the information processing apparatus 600 detects whether or not there are the staff number and the password that match on the authentication table 606b. In the case that there are the staff number and the password that match on the authentication table 606b, the information processing apparatus 600 allows the user to log in.

Furthermore, in the case that a user authentication of the staff number “100001” is performed, the information processing apparatus 600 grants an administrator authority to the user.

Additionally, although a staff number is used as a user ID for user authentication in the example illustrated in FIG. 18, a user ID is not limited to a staff number. Any kind of codes that identifies a user, such as an e-mail address, can be used as a user ID.

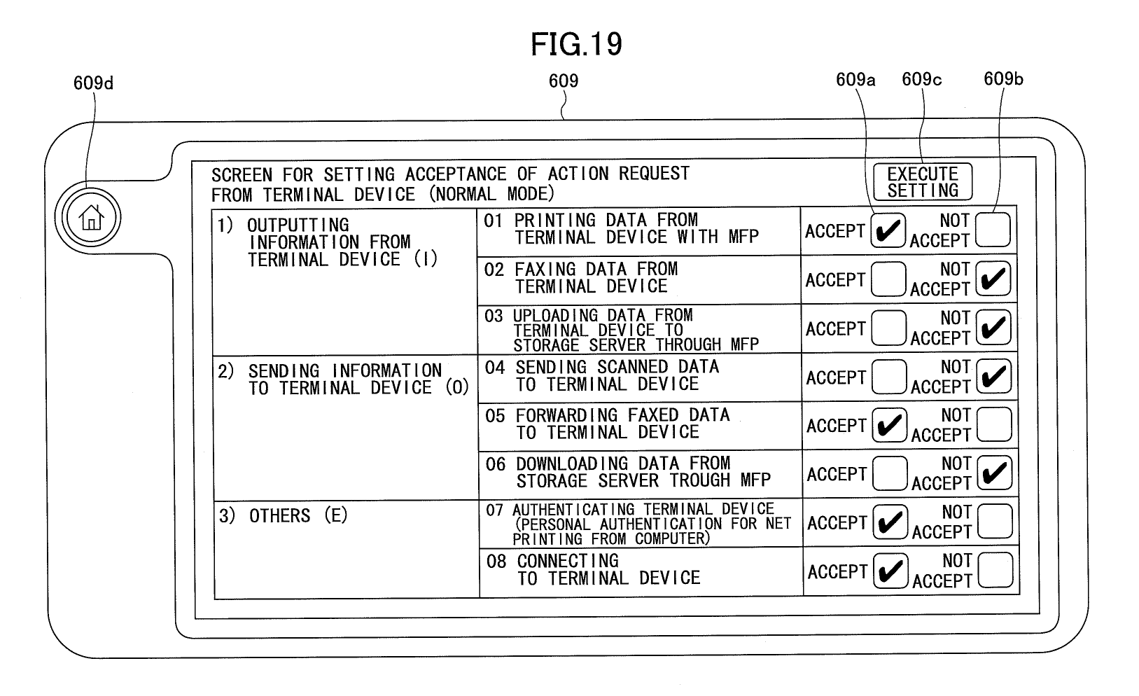

FIG. 19 is a drawing illustrating a first example of an operation panel displayed on the display unit 609. In case that a user having an administrator authority logs in after a log-in authentication is performed on the operation panel, the display unit 609 displays the operation panel illustrated in FIG. 19.

The operation panel displayed on the display unit 609 is used for executing a setting concerning an acceptance of action requests in the case that an identification number of an action request is sent when the terminal device 100 is on the normal mode. The first row from the left end of the operation panel indicates a category of an action request, and “1) outputting information from the terminal device”, “2) sending information to the terminal device”, “3) others” correspond to category “I”, “O”, and “E” in FIG. 3, respectively. Furthermore, the second row from the left end of the operation panel indicates a kind of an action request, and a number assigned to each action request corresponds to the identification number of the action request illustrated in FIG. 3.

Furthermore, the third row from the left end of the operation panel indicates a setting concerning an acceptance of each action request, where a user can select ether “accept” or “not accept”. In the case that “accept” is selected, the information processing apparatus 600 permits an execution of an action request sent through the terminal device 100 during the normal mode, whereas in the case that “not accept” is selected, the information processing apparatus 600 rejects an execution of an action request sent through the terminal device 100 during the normal mode. When a setting executing button 609c is tapped, the information processing apparatus 600 reflects the setting selected on the operation panel. Furthermore, when a home button 609d is tapped, the information processing apparatus 600 displays a home screen.

As an example, in the case that “accept” of a check box 609a is selected, the information processing apparatus 600 prints out data sent from the terminal device 100 as a response to an action request with identification number “01” sent through the terminal device 100 during the normal mode. On the other hand, in the case that “not accept” of a check box 609b is selected, the information processing apparatus 600 rejects printing out data sent from the terminal device 100 as a response to an action request with identification number “01” sent through the terminal device 100 during the normal mode, and sends to the terminal device 100 the message “action cannot be performed because the device is not on the security mode”.

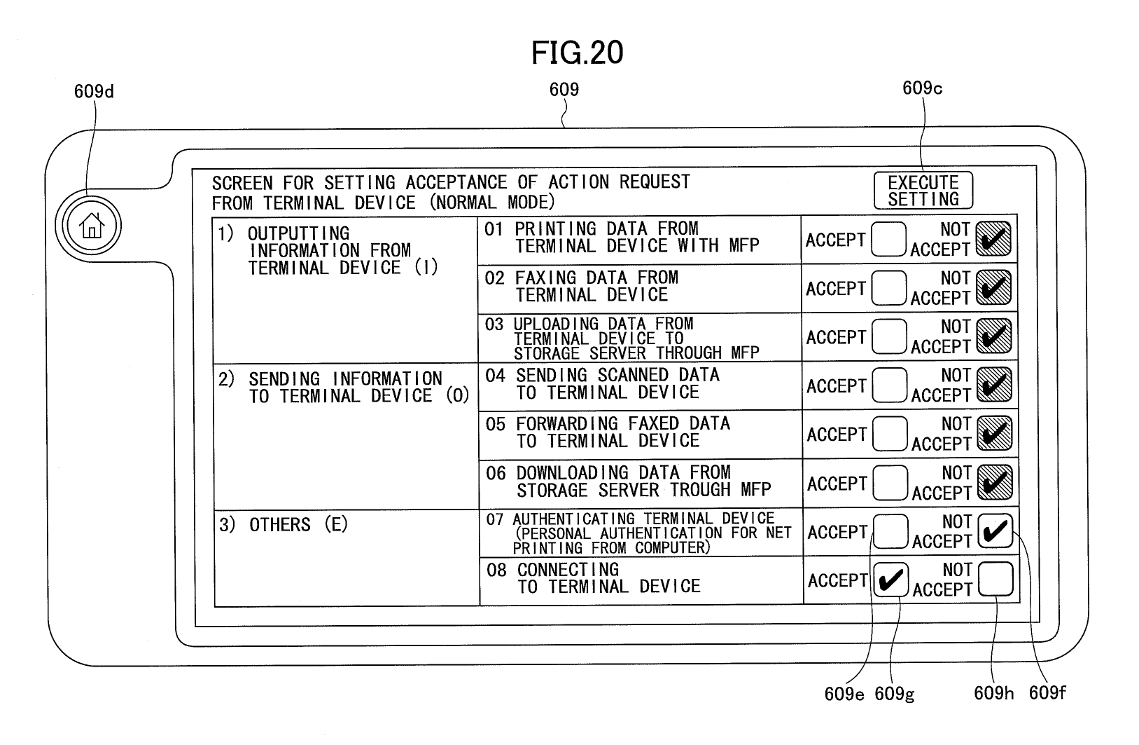

FIG. 20 is a drawing illustrating a second example of the operation panel displayed on the display unit 609. FIG. 20 and FIG. 19 are different in the way that “not accept” of a check box 609f is selected regarding the action request with identification number “07” in FIG. 20. In the case that “not accept” of the check box 609f is selected, the information processing apparatus 600 rejects a user authentication of the terminal device 100, as well as the action requests with identification numbers “01” through “06”. Furthermore, the information processing apparatus 600 may preset all the check boxes of identification numbers “01” through “06” fixedly to “not accept”, thereby allowing no user to select “accept”.

Additionally, the information processing apparatus 600 may reject the action requests of identification numbers “01” through “06” even in the case that “not accept” of a check box 609h is selected regarding the action request with identification number “08”.

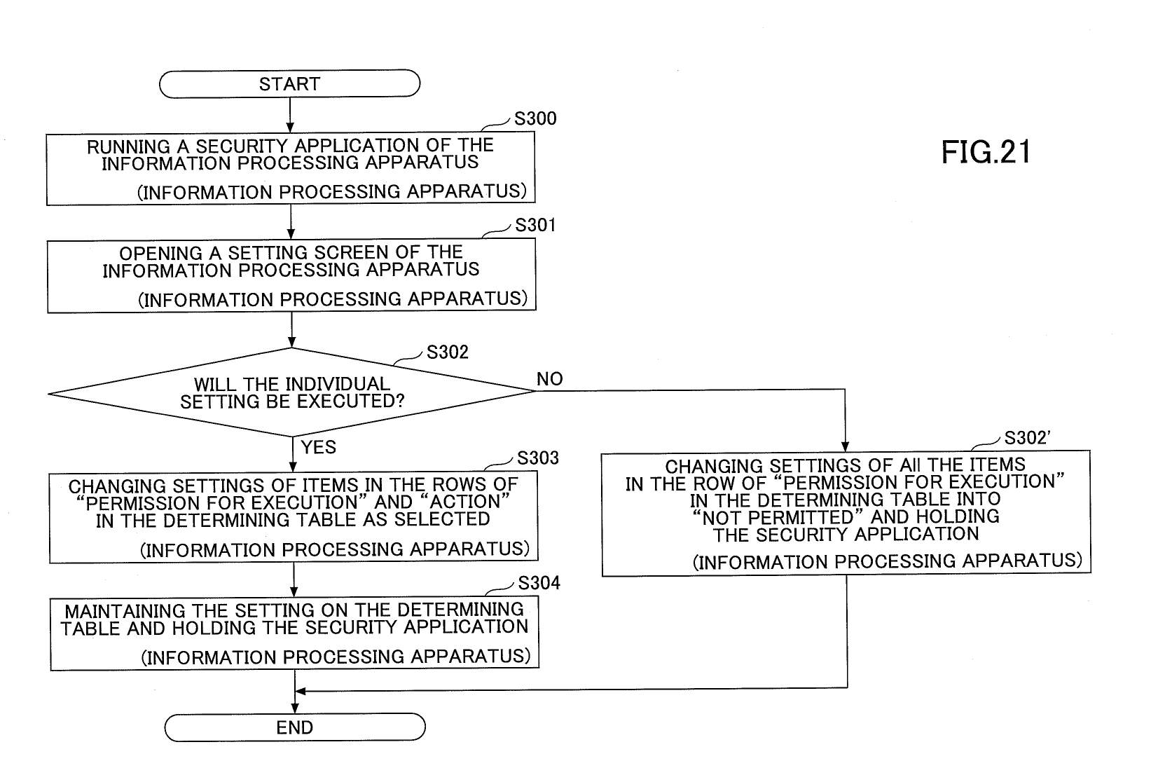

FIG. 21 is a drawing illustrating a flowchart of setting an acceptance of an action request. The information processing apparatus 600 runs a security application (step S300). Subsequently, the information processing apparatus 600 displays a setting screen on the operation panel for setting of the apparatus itself (step S301).

After the individual setting is completed, the information processing apparatus 600 determines whether the individual setting is executed (step S302). In the case that the individual setting is determined not to be executed (step S302 No), the information processing apparatus 600 changes settings of all the items in the row of “permission for execution” in the determining table 606a into “not permitted”, where all the action requests in the row of “action” are rejected, then holds the security application. On the other hand, in the case that the individual setting is determined to be executed (step S302 YES), the information processing apparatus 600 changes settings of items in the rows of “permission for execution” and “action” in the determining table 606a as selected on the setting screen (step S303). The information processing apparatus 600 maintains the setting on the determining table 606a and holds the security application.

(Hardware Configuration of MFP/LP Relating to Information Processing Apparatus)

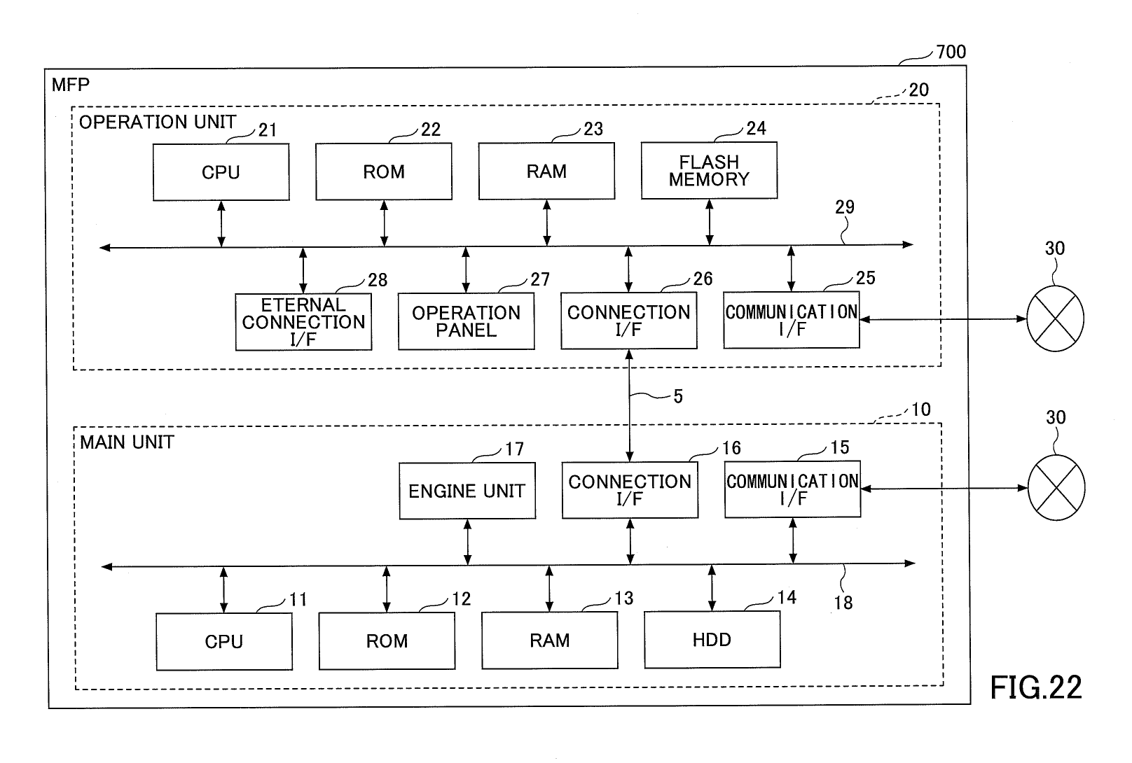

FIG. 22 is a drawing illustrating an example of a hardware configuration of an MFP/LP 700 relating to the information processing apparatuses described in the first embodiment through the third embodiment. As illustrated in FIG. 22, the MFP/LP 700 includes a main unit 10 which can perform various functions such as a copy function, a scanner function, a fax function, and a printer function, as well as an operation unit 20 where a user operation is entered. Here, the term “entering a user operation” means entering information being input in response to a user operation (such as a signal indicating a coordinate value of a screen). The main unit 10 and the operation unit 20 are connected via a communication path 5 for mutual communications. The communication path 5 may be configured with an arbitrary standard, regardless of wired or wireless, such as USB (Universal Serial Bus) standard.

Additionally, the main unit 10 is capable of performing actions responding to an operation entered in the operation unit 20. Furthermore, the main unit 10 is capable of communicating with external devices such as a client PC (personal computer) to perform actions responding to instructions received from the external devices.

In the following, a description of a hardware configuration of the main unit 10 is given. As illustrated in FIG. 22, the main unit 10 includes a CPU 11, a ROM (Read Only Memory) 12, a RAM (Random Access Memory) 13, an HDD (Hard Disk Drive) 14, a Communication I/F 15, a connection I/F 16, and an engine unit 17, which are mutually connected via a system bus 18.

The CPU 11 centrally controls the actions performed by the main unit 10. The CPU 11 executes programs stored in the ROM 12, he HDD 14, etc., utilizing the RAM 13 as a work area, to control the entire action of the main unit 10 and to perform various functions such as the above described copy function, scanner function, fax function, and printer function. Additionally, the CPU 11 performs the process of each functional unit of the information processing apparatus 200 relating to FIG. 6, the information processing apparatus 500 relating to FIG. 11, and the information processing apparatus 600 relating to FIG. 16.

The communication I/F 15 is an interface to connect to the network 30. The connection I/F 16 is an interface to communicate with the operation unit 20 via the communication path 5. The engine unit 17 is a hardware unit which performs processes other than general information processing and connecting, that is, performs processes for executing the copy function, the scanner function, the fax function, and the printer function. As an example, the engine unit 17 is equipped with a scanner (an image scanning unit) which scans and reads an image of a document, a plotter (an image plotting unit) which performs printing on a sheet material such as a paper, and a faxing unit which performs a facsimile communication. Furthermore, the engine unit 17 may be equipped with specific options such as a finisher which sorts printed sheets and an ADF (Auto Document Feeder) which automatically feeds documents.

In the following, a description of a hardware configuration of the operation unit 20 is given. As illustrated in FIG. 22, the operation unit 20 includes a CPU 21, a ROM 22, a RAM 23, a flash memory 24, a communication I/F 25, a connection I/F 26, an operation panel 27, and an external connection I/F 28, which are mutually connected via a system bus 29. In addition, the operation panel 27 is an example corresponding to the display unit 609 in FIG. 16.

The CPU 21 centrally controls the actions performed by the operation unit 20. The CPU 21 executes programs stored in the ROM 22, the flash memory 24, etc., utilizing the RAM 23 as a work area, to control the entire action of the operation unit 20 and to perform various functions as described below such as displaying information (image) responding to an input received from a user.

The communication I/F 25 is an interface to connect to the network 30. The connection I/F 26 is an interface to communicate with the main unit 10 via the communication path 5.

The operation panel 27 accepts various inputs such as setting information responding to a user operation and displays various information items (for example, information responding to an accepted operation, information showing an operating status of the MFP/LP 700, and information showing a setting status). Although the operation panel 27 is configured with an LCD (Liquid Crystal Display) having a touch panel function in the example here, the operation panel 27 is not limited to the LCD. For example, the operation panel 27 may be configured with an organic electroluminescent display having a touch panel function. Additionally or alternatively, the operation panel 27 may be equipped with an operation part such as a hardware key or a display part such as a lamp.

The external connection I/F 28 is an interface to connect to an IC card reader.

(Software Configuration of MFP/LP)

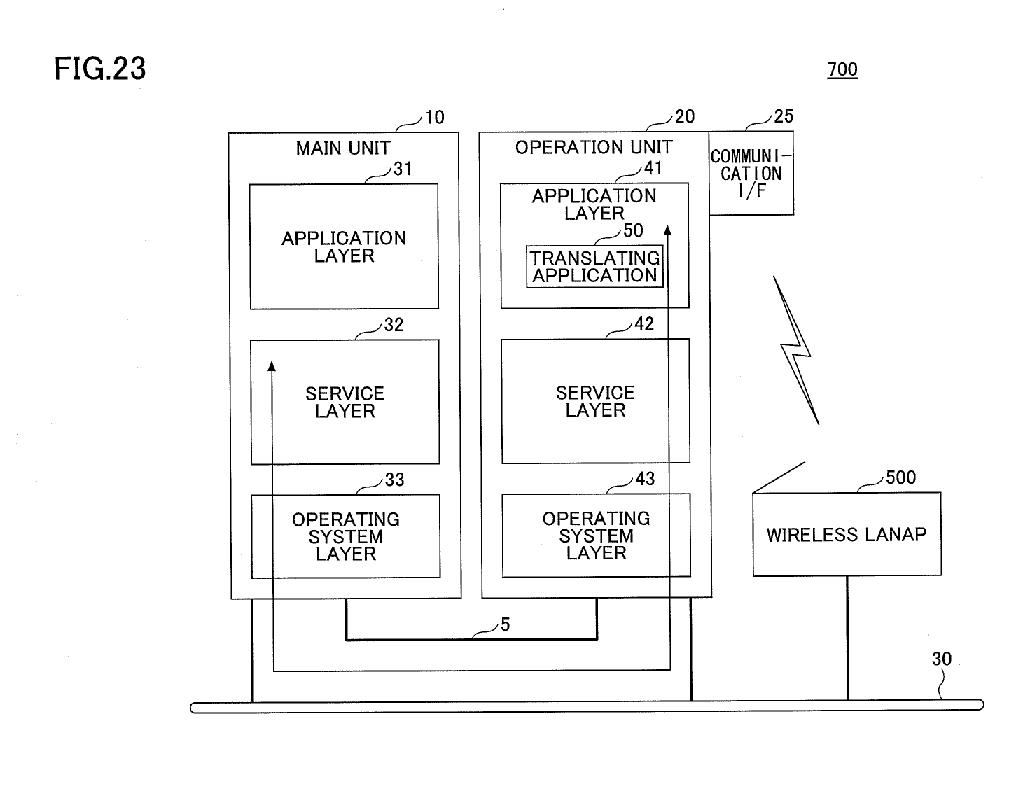

FIG. 23 is a block diagram illustrating an example of a software configuration of the MFP/LP 700. As illustrated in FIG. 23, the main unit 10 includes an application layer 31, a service layer 32, and an operating system layer 33. The application layer 31, the service layer 32, and the operating system layer 33 are substantially software programs stored in the ROM 12, the HDD 14, etc. The CPU 11 executes such software programs to provide various functions.

Software programs in the application layer 31 are application software programs, which may be simply called an “application” in the following description. These software programs cause hardware resources to provide relevant functions. Examples of applications are a copy application to provide a copy function, a scanner application to provide a scanner function, a fax application to provide a fax function, and a printer application to provide a printer function.

Software programs in the service layer 32, situated between the application layer 31 and the operating system layer 33, provide interfaces that allow applications to use hardware resources installed in the main unit 10. More specifically, the software programs in the service layer 32 provide functions of receiving and mediating action requests toward the hardware resources. Examples of the action requests that the service layer 32 receives are considered to be a scanning request to the scanner, a printing request to the plotter, etc.

Additionally, the service layer 32 provides the interfacing function not only to the application layer 31 in the main unit 10, but also to the application layer 41 in the operation unit 20. In other words, the application layer 41 in the operation unit 20 (application) is capable of executing functions using the hardware resources of the main unit 10 (such as the engine unit 17) as well, through the interfacing function of the service layer 32.

A software program in the operating system layer 43 is basic software to provide a basic function to control the hardware resources installed in the main unit 10. Software programs in the service layer 42 convert requests for using hardware resources from various applications into commands that the operating system layer 43 can interpret, and then passes the converted commands to the operating system layer 43. When the software program in the operating system layer 43 executes the commands, the hardware resources perform actions according to the requests from the applications.

Similarly to the main unit 10, the operation unit 20 includes the application layer 41, the service layer 42, and the operating system layer 43. The application layer 41, the service layer 42, and the operating system layer 43 installed in the operation unit 20 are the same as the layers installed in the main unit 10, in terms of the layering configuration. However, the layers installed in the operation unit 20 are different from the layers installed in the main unit 10 in terms of the functions that the applications in the application layer 41 provide and the types of the action requests that the service layer 42 can receive. Although applications in the application layer 41 may be software programs that operate hardware resources installed in the operation unit 20 to provide relevant functions, the applications in the application layer 41 are mainly software programs that provide UI (User Interface) in order to operate and to display functions installed in the main unit 10 (such as a copy function, a scanner function, a fax function, and a printer function).

A wireless LANAP (Local Area Network Access Point) 500 is an access point that receives processing requests such as a copying request, a scanning request, a faxing request, and a printing request from a terminal device of a user.

Additionally, in the embodiments, software programs in the operating system layer 33 of the main unit 10 and software programs in the operating system layer 43 of the operation unit 20 are different in order to ensure independence of the functions. In other words, the main unit 10 and the operation unit 20 are operated independently by separate operating systems. For example, Linux® may be used as a software program in the operating system layer 33 of the main unit 10 and Android® may be used as a software program in the operating system layer 43 of the operation unit 20.

As described above, in the MFP/LP 700 of the embodiments, the main unit 10 and the operation unit 20 are operated by separate operating systems, therefore communications between the main unit 10 and the operation unit 20 are performed as communications between separate devices, not as inter-process communications within the same device. Examples of the communications are a transmission of information received from the operation unit 20 (an instruction from a user) to the main unit 10 (a command transmission), a notification of an event from the main unit 10 to the operation unit 20, etc. Here, the operation unit 20 performs command transmissions to the main unit 10 in order to utilize functions of the main unit 10. Furthermore, examples of the events reported from the main unit 10 to the operation unit 20 are an operating status and a setting status of the main unit 10, etc.

Furthermore, although a supply of electricity to the operation unit 20 is provided through the communication path 5 from the main unit 10 in the embodiments, power supply control of the operation unit 20 may be performed separately (independently) from power supply control of the main unit 10.

In the following, a description of a recording medium storing programs and data used to execute the processes described above is given. Examples of the recording medium are a CD-ROM, a magnetic optical disk, a DVD-ROM, an FD, a flash memory, a memory card, a memory stick, and other kinds of ROM and RAM. A computer executes a program stored in such recording media to perform the processes described in the embodiments. Additionally, programs as described above, which are used for processing a communication control method, for performing a function of a serial communication device, etc., may be distributed in the form of a recording medium, through the network, or the like, thereby allowing the functions to be performed more conveniently.

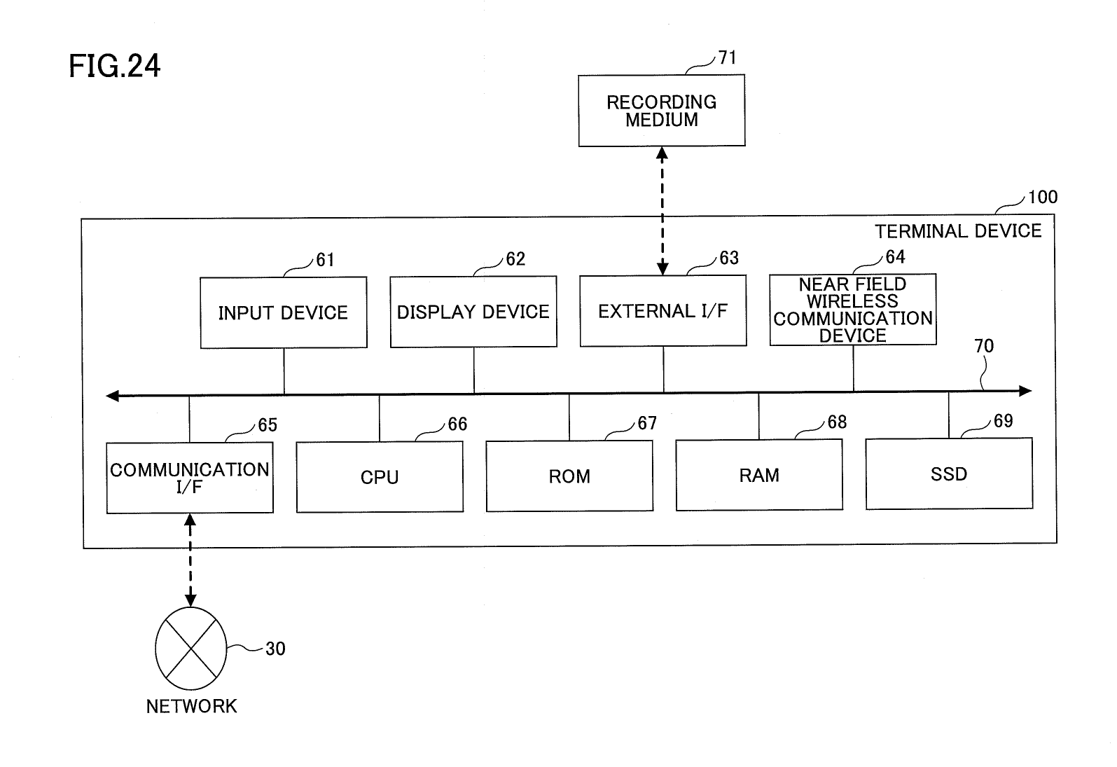

FIG. 24 is a drawing illustrating an example of a hardware configuration of the terminal device 100. The terminal device 100 includes an input device 61, a display device 62, an external I/F 63, a near field wireless communication device 64, a communication I/F 65, a CPU 66, a ROM 67, a RAM 68, and an SSD (Solid State Drive) 69, which are mutually connected via a bus 70. Moreover, the terminal device 100 may include an imaging device and various types of sensors such as a location sensor, an angle sensor, and acceleration sensor.

The input device 61 is a device for a user to input operations, and the terminal device 100 includes one or more input devices such as a touch-input device, a button-input device, and a voice-input device. The touch-input device detects that a user touches a part of the terminal device 100 and generates an input signal. The button-input device detects that a user presses a button mounted on the terminal device 100 and generates an input signal. The voice-input device detects a user's voice input using a microphone mounted on the terminal device 100 and decodes the input information. The voice input and the corresponding functions to be performed are stored, for example, on a table in a memory unit. Moreover, a keyboard and a mouse may be mounted on the terminal device 100.

The display device 62, which may be a touch screen, for example, displays electronic data (such as an electronic document, an image, and a message to a user) for a user to see.

The external I/F 63 is an interface for external devices such as a recording medium (SD card) 71. The terminal device 100 is capable of reading and writing on the recording medium through the external I/F 63. Examples of the recording medium 71 are an SD card, a USB memory, a flexible disk, etc.

Examples of the near field wireless communication device 64 are an NFC (Near Field Communication) tip, etc. The terminal device 100 can perform data communications through the near field wireless communication device.

The communication I/F 65 is an interface for connecting the terminal device 100 to the cellular network, the Internet, etc. The terminal device 100 can perform data communications through the connection I/F 65.

The CPU 66 retrieves programs and data from a memory device such as the ROM 67 and the SSD 69 and executes processing using the RAM 68, in order to perform the entire control and the functions of the terminal device 100. The CPU 66 may solely perform processing of both a normal area and a security area, or more than one CPU 66 may separately perform processing of the normal area and the security area.

The ROM 67 is a non-volatile semiconductor memory which is capable of maintaining programs and data even after the power is turned off. The ROM 67 stores a BIOS, which is executed when the terminal device 100 is turned on, an operating system setting, a networking setting, etc. The RAM 68 is a volatile semiconductor memory which temporarily maintains programs and data. Memories such as RAMs and ROMs separately have the normal area, which stores and processes programs to be used for normal use (a normal operating system and normal applications) and processed data, and the security area, which stores and processes programs with enhanced security levels (a sub operating system and security applications), encryption methods, etc. Additionally, the normal area and the security area may be separated using more than one RAM and ROM.

The SSD 69 is a non-volatile memory device which stores programs and data. Examples of stored programs and data are an operating system for the entire control of the terminal device, and application software programs to provide various types of functions which are operated on the operating system. The SSD manages stored programs and data on a predetermined file system and/or database. The SSD may be replaced with an HDD. Similarly to the memories, the SSD 69 includes a normal area and a security area, which are independent and are not allowed mutual communications. The security area stores programs with enhanced security levels (such as a document editing application which can limit outputs for browsing documents), encrypted data, etc. The normal area and the security area may be separated using more than one memory.

Further, the present invention is not limited to these embodiments, but various variations and modifications may be made without departing from the scope of the present invention.

Additionally, in the period after the terminal device 100 sends an action request to the information processing apparatus 200 and before the information processing apparatus 200 performs the action, an interaction may be conducted to confirm that the security application is running. For example, in case that the terminal device 100 sends an operation to the information processing apparatus 200 to confirm that the security application is running, the security application of the information processing apparatus 200 sends a signal to the terminal device 100 to report that the security application is running. After the terminal device 100 receives the signal from the information processing apparatus 200, the security application of the terminal device 100 sends a request to perform an action to the information processing apparatus 200. Additionally, in the case of not receiving the signal that reports that the security application is running, the security application of the terminal device 100 denies the request, and then notifies a user that the information processing apparatus 200 does not support the security mode.

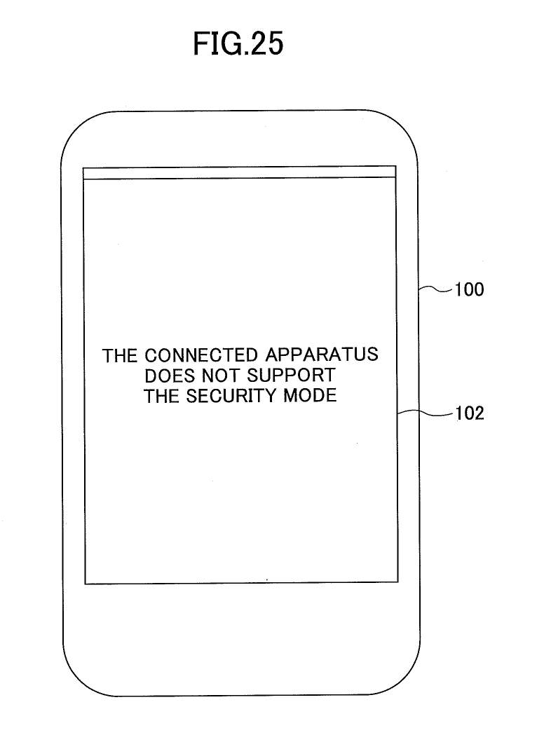

FIG. 25 is a drawing illustrating an example of a screen for reporting that the information processing apparatus 200 does not support the security function. For example, in the case of not receiving a signal indicating that the security application is running from the information processing apparatus 200 in a predetermined period, the terminal device 100 displays a screen illustrated in FIG. 25 on the monitor 102.

Additionally, in the embodiments, the processing apparatus 200 is an example of a relevant information processing apparatus. The mode switching unit 113a and 113b are examples of a switching unit. The mode identifying information generating unit 103 is an example of a generating unit. The communication unit 130 is an example of a sending unit. The execution unit 207 is an example of an execution unit. The reception unit 203 is an example of a receiving unit.

What is claimed is:

1. An information processing system comprising:
a terminal device; and
an information processing apparatus configured to execute one of a plurality of actions in response to an action request from the terminal device,
wherein the terminal device includes
a switching unit configured to switch modes between a first mode used for requesting an external apparatus to execute an action and a second mode used for requesting the information processing apparatus to execute an action, the external apparatus being any one of the information processing apparatus and one or more other apparatuses;
a generating unit configured to generate mode identifying information indicative of a mode used for generating the action request; and
a sending unit configured to send the action request and the mode identifying information, and
wherein the information processing apparatus includes an execution unit configured to limit execution of an action requested by the action request for which the mode identifying information indicates the first mode when the requested action is among a predetermined one or more of the plurality of actions, and configured to execute, regardless of which one of the plurality of actions the requested action is, the requested action for which the mode identifying information indicates the second mode.

2. The information processing system according to claim 1,
wherein the sending unit of the terminal device is further configured to send an authentication request for performing user authentication, and wherein the execution unit of the information processing apparatus is configured to determine, based on a result of the user authentication and the mode identifying information, whether or not to execute the requested action.

3. The information processing system according to claim 2,
wherein the execution unit of the information processing apparatus is configured to reject performing user authentication in the case that the mode identifying information received from the terminal device indicates the first mode.

4. The information processing system according to claim 1,
wherein the information processing apparatus is configured to send an instruction to the terminal device to switch the mode to the second mode in the case that the mode identifying information received from the terminal device indicates the first mode.

5. An information processing apparatus configured to execute one of a plurality of actions in response to an action request from a terminal device, the information processing apparatus comprising:
a receiving unit configured to receive from the terminal device mode identifying information for distinguishing between a first mode used for requesting an external apparatus to execute an action and a second mode used for requesting the information processing apparatus to execute an action, the external apparatus being any one of the information processing apparatus and one or more other apparatuses, and configured to receive from the terminal device the action request; and
an execution unit configured to limit execution of an action requested by the action request for which the mode identifying information indicates the first mode when the requested action is among a predetermined one or more of the plurality of actions, and configured to execute, regardless of which one of the plurality of actions the requested action is, the requested action for which the mode identifying information indicates the second mode.

6. The information processing apparatus according to claim 5,
wherein the execution unit is configured not to execute the requested action in a case of not receiving the mode identifying information in the receiving unit.

7. A method for processing information, wherein an information processing apparatus executes one of a plurality of actions in response to an action request from a terminal device, the method comprising:
receiving from the terminal device mode identifying information for distinguishing between a first mode used for requesting an external apparatus to execute an action and a second mode used for requesting the information processing apparatus to execute an action, the external apparatus being any one of the information processing apparatus and one or more other apparatuses, and receiving from the terminal device the action request; and
limiting execution of an action requested by the action request for which the mode identifying information indicates the first mode when the requested action is among a predetermined one or more of the plurality of actions, and executing, regardless of which one of the plurality of actions the requested action is, the requested action for which the mode identifying information indicates the second mode.
